(19) United States
(12) Patent Application Publication
(10) Pub. No.: US 2014/0067882 A1
(43) Pub. Date: Mar. 6, 2014

(54) INFORMATION PROCESSING APPARATUS, CONTROL METHOD THEREOF, SYSTEM, AND NON-TRANSITORY COMPUTER-READABLE MEDIUM

(71) Applicant: CANON KABUSHIKI KAISHA, Tokyo (JP)

(72) Inventor: Yuma Ikeuchi, Tokyo (JP)

(73) Assignee: CANON KABUSHIKI KAISHA, Tokyo (JP)

(21) Appl. No.: 13/956,775

(22) Filed: Aug. 1, 2013

(30) Foreign Application Priority Data
Aug. 29, 2012 (JP) 2012-188924

(51) Int. Cl. G06F 17/30

(52) U.S. Cl. CPC G06F 17/30067
USPC 707/821

(57) ABSTRACT

An information processing apparatus, which communicates with a server, comprises: a receiving unit which receives character string information and a data file to be associated with the character string information from a user; an extraction unit which extracts a data file similar to the data file received by the receiving unit and character string information associated with the similar data file by searching information managed by the server; an acquisition unit which acquires tag information appended to the character string information extracted by the extraction unit; and a registration unit which appends the tag information acquired by the acquisition unit to the character string information received by the receiving unit, and registers the character string information appended with the tag information and the data file received by the receiving unit in the server in association with each other.

### BACKGROUND OF THE INVENTION

1. Field of the Invention

The present invention relates to an information processing apparatus which communicates with a server, a control method thereof, system, and a non-transitory computer-readable medium.

2. Description of the Related Art

In recent years, as a system form that provides services using the Internet, a cloud computing system has been put to practical use. As an already available cloud service, CRM (Customer Relationship Management) services which provide a CRM system function used to make customer management and sales support are known. Also, as other cloud services, document management services which provide storage and management functions used to store and manage digital files are known.

Some CRM services provided as cloud services provide a microblog function as a business communication tool. These cloud services link customer information and sales negotiation information with messages and comments, thus further improving users' convenience. At the same time, some CRM services provide a file sharing function which allows users to share files so as to store, edit, update, and refer to files. For example, as the microblog function provided by Salesforce.com, inc., Chatter® is available. As the file sharing function, “Document” and “File” are available.

Also, in recent years, an image processing apparatus which incorporates not only basic functions such as a scan function and print function, which digitize and print paper documents, but also a network interface (to be abbreviated as a network I/F hereinafter) has been developed. For example, the image processing apparatus which incorporates a network I/F can transmit to and store in a cloud document management service an image file formed by scanning paper documents. Also, information associated with an image file stored in the cloud document management service or stored in the image processing apparatus itself is registered as a “message” in the microblog function of the cloud service. Thus, other users of the cloud service can be notified of such an image file. Therefore, this function allows image files to be delivered to other users.

On the other hand, a technique which sets a specific search pattern designated by the user as a search condition, detects documents including matching image elements from a storage device, and presents the documents to the user is known (see Japanese Patent Laid-Open No. 2008-146603).

An information processing apparatus, which has a function of registering a “message” by attaching an image file to the microblog function provided by the cloud service, will be assumed. Also, assume that in the microblog function, the message with an attached image file is registered as an independent new message. A case will be examined below wherein a user A registers a message with an attached image file in the microblog function using an image processing apparatus. In this case, assuming that the user A registers a message A, another user may refer to an image file of the message A, and may add a modification of the image file as a comment. When the user A reflects the modification item of the comment to the image file, and registers the modified image file to the microblog function, it is registered as an independent message B in place of a comment associated with the message A depending on the specifications of the microblog function. A case will be examined below wherein another user wants to confirm a difference between the image files of the messages A and B on the microblog. At this time, that user bears a heavy burden of confirming the modification to the attached file since both the messages A and B are independent messages.

### SUMMARY OF THE INVENTION

The present invention has been made in consideration of the aforementioned problems, and provides a mechanism that allows the user to easily associate data files with each other.

According to one aspect of the present invention, there is provided an information processing apparatus, which communicates with a server which manages character string information, a data file associated with the character string information, and character string information added in association with the character string information, the apparatus comprising: a receiving unit configured to receive character string information and a data file to be associated with the character string information from a user; an extraction unit configured to extract a data file similar to the data file received by the receiving unit and character string information associated with the similar data file by searching information managed by the server; an acquisition unit configured to acquire tag information appended to the character string information extracted by the extraction unit; and a registration unit configured to append the tag information acquired by the acquisition unit to the character string information received by the receiving unit, and to register the character string information appended with the tag information and the data file received by the receiving unit in the server in association with each other.

According to another aspect of the present invention, there is provided an information processing apparatus connected to a server which manages character string information and character string information added in association with the character string information, the apparatus comprising: a registration unit configured to append, when tag information is not appended to character string information managed by the server, new tag information to the character string information added in association with the character string information, and to register the character string information in the server.

According to another aspect of the present invention, there is provided a system including a server and an information processing apparatus, wherein the server comprises: a management unit configured to manage character string information, a data file associated with the character string information, and character string information added in association with the character string information; and a display unit configured to provide a window used to display information managed by the management unit based on association of the information, and the information processing apparatus comprises: a receiving unit configured to receive character string information and a data file to be associated with the character string information from a user; an extraction unit configured to extract a data file similar to the data file received by the receiving unit and character string information associated with the similar data file by searching information managed by the server; an acquisition unit configured to acquire tag information appended to the character string information extracted by the extraction unit; and a registration unit configured to append the tag information acquired by the acquisition unit to the character string information received by the receiving unit, and to register the character string information appended with the tag information and the data file received by the receiving unit in the server in association with each other.

According to another aspect of the present invention, there is provided a control method of information processing apparatus, which communicates with a server which manages character string information, a data file associated with the character string information, and character string information added in association with the character string information, the method comprising: a receiving step of receiving character string information and a data file to be associated with the character string information from a user; an extraction step of extracting a data file similar to the data file received in the receiving step and character string information associated with the similar data file by searching information managed by the server; an acquisition step of acquiring tag information appended to the character string information extracted in the extraction step; and a registration step of appending the tag information acquired in the acquisition step to the character string information received in the receiving step, and registering the character string information appended with the tag information and the data file received in the receiving step in the server in association with each other.

According to another aspect of the present invention, there is provided a control method of an information processing apparatus connected to a server which manages character string information and character string information added in association with the character string information, the method comprising: a registration step of appending, when tag information is not appended to character string information managed by the server, new tag information to the character string information added in association with the character string information, and registering the character string information in the server.

According to another aspect of the present invention, there is provided a non-transitory computer-readable medium storing a program for controlling a computer, which communicates with a server which manages character string information, a data file associated with the character string information, and character string information added in association with the character string information, to function as: a receiving unit configured to receive character string information and a data file to be associated with the character string information from a user; an extraction unit configured to extract a data file similar to the data file received by the receiving unit and character string information associated with the similar data file by searching information managed by the server; an acquisition unit configured to acquire tag information appended to the character string information extracted by the extraction unit; and a registration unit configured to append the tag information acquired by the acquisition unit to the character string information received by the receiving unit, and to register the character string information appended with the tag information and the data file received by the receiving unit in the server in association with each other.

According to another aspect of the present invention, there is provided a non-transitory computer-readable medium storing a program for controlling a computer, which communicates with a server which manages character string information and character string information added in association with the character string information, to function as: a registration unit configured to append, when tag information is not appended to character string information managed by the server, new tag information to the character string information added in association with the character string information, and to register the character string information in the server.

The user can easily associate data files with each other.

Further features of the present invention will become apparent from the following description of exemplary embodiments (with reference to the attached drawings).

### BRIEF DESCRIPTION OF THE DRAWINGS

FIG. 1 is a block diagram showing an arrangement example of the overall system;

FIG. 2 is a block diagram showing an arrangement example of an image processing apparatus;

FIG. 3 is a block diagram showing an arrangement example of a microblog service server;

FIG. 4 is a block diagram showing an arrangement example of a microblog cooperative service server;

FIG. 5 is a block diagram showing software configuration examples of respective apparatuses included in the system;

FIG. 6 is a sequence chart showing operations required to execute a series of processes according to the first embodiment;

FIG. 7 is a flowchart showing user owned image file search processing;

FIG. 8 is a flowchart showing similar image tag acquisition processing according to the first and third embodiments;

FIG. 9 is a view showing a configuration example of an authentication window;

FIG. 10 is a view showing a configuration example of a scan setting window;

FIG. 11 is a view showing a configuration example of a message registration window according to the first embodiment;

FIG. 12 is a view showing a configuration example of a message registration completion window;

FIG. 13 is a view showing a state of the microblog function before the sequence according to the first embodiment;

FIG. 14 is a view showing an example of an image file;

FIG. 15 is a view showing an example of a similar image file to the image file shown in FIG. 14;

FIG. 16 is a view showing an example of a non-similar image file to the image file shown in FIG. 14;

FIG. 17 is a view showing a state of the microblog function after the sequence according to the first embodiment;

FIG. 18 is a view showing a state of the microblog function before a sequence according to the second embodiment;

FIG. 19 is a sequence chart showing operations required to execute a series of processes according to the second embodiment;

FIG. 20 is a flowchart showing the operation of similar image tag acquisition processing according to the second embodiment;

FIG. 21 is a view showing a configuration example of a message registration window according to the second embodiment;

FIG. 22 is a view showing a state of the microblog function after the sequence according to the second embodiment; and

FIG. 23 is a sequence chart showing operations required to execute a series of processes according to the third embodiment.

### DESCRIPTION OF THE EMBODIMENTS

Embodiments of the present invention will be described in detail hereinafter with reference to the drawings. Note that the following embodiments do not limit the inventions related to the scope of the claims, and all of the characteristic features of the combinations described in the embodiments are not necessarily indispensable for the solving means of the invention.

### First Embodiment

[System Arrangement]

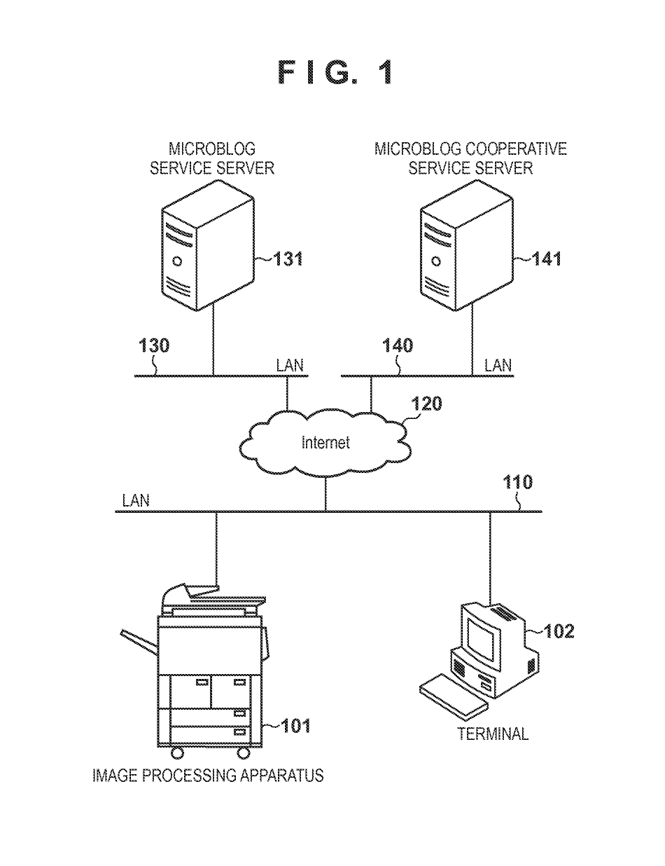

FIG. 1 is a block diagram showing the overall system according to this embodiment. To a LAN (Local Area Network) 110, an image processing apparatus 101 and a terminal 102 as an information processing apparatus such as a PC (Personal Computer) are connected. The LAN 110 is connected to the Internet 120, and is also connected to a microblog service server 131 and microblog cooperative service server 141, which provide services on the Internet 120, via the Internet 120. With the above arrangement, the image processing apparatus 101 and terminal 102 can communicate with the microblog service server 131 and microblog cooperative service server 141.

The microblog function used in the present invention will be briefly described below. The microblog function is a short blog function which allows a user having an account on a service to publish short text (character string information) of about 100 to 200 characters, which is called “tweet” as a message or comment. The “user” includes, for example, objects, applications, and the like on the cloud service such as printers and cooperative services, and is not limited to an existing user (human being). Respective messages and comments published by the user are assigned with unique identifiers.

The microblog function creates a timeline which can register, display, and manage comments associated with a message registered by the user as a list. The user who registered the message and other users exchange information by registering related information as comments on this timeline, so as to communicate with each other. Each user account also has a function of managing a user's profile, and allows each user to recognize communication partners. For example, pieces of information such as a user's name, contact information (mail address, telephone number, address, etc.), and a group to which the user belongs are managed.

Also, one or a plurality of comments can be associated with one message. That is, the user registers arbitrary character string information in association with a message to confirm associations between a message and comments on the timeline. Furthermore, one or a plurality of data files can be associated with one message.

A tag (tag information) can be appended to a message or comment, and the microblog function displays appended tags on a window to indicate associations between messages and comments.

Note that more detailed cooperations and displays between the present invention and the microblog function will be described later.

(Image Processing Apparatus)

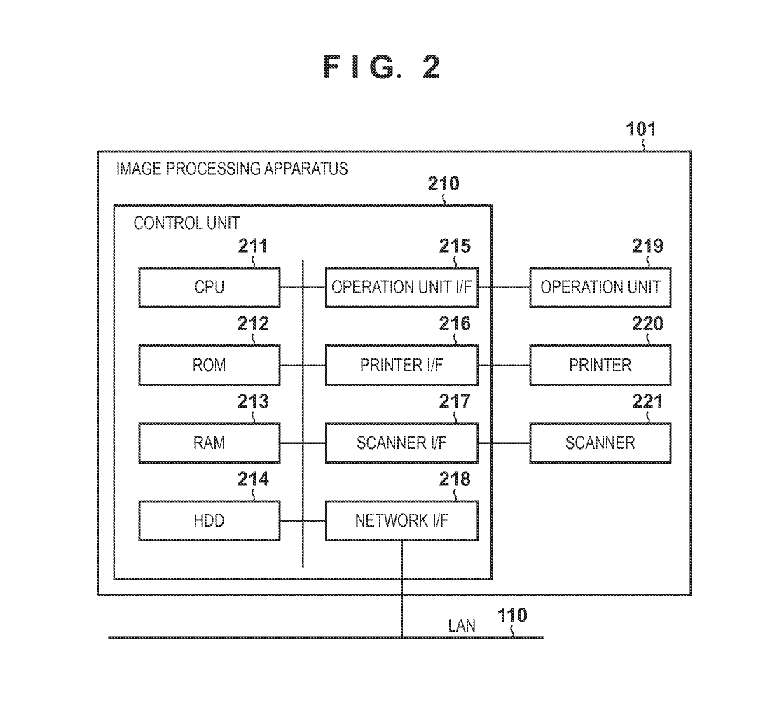

FIG. 2 is a block diagram showing the arrangement of the image processing apparatus 101. A control unit 210 including a CPU 211 controls the operations of the overall image processing apparatus 101. The CPU 211 executes various kinds of control such as read control and transmission control by reading out control programs stored in a ROM 212. A RAM 213 is used as temporary storage areas such as a main memory and work area of the CPU 211. An HDD 214 stores image files, various programs, or various information tables.

An operation unit I/F 215 connects between an operation unit 219 and the control unit 210. The operation unit 219 includes a liquid crystal display unit having a touch panel function, a keyboard, and the like. Also, the image processing apparatus 101 includes an application 410 (to be described later). The application 410 of the image processing apparatus 101 displays an operation window required to communicate with a Web server on the liquid crystal display unit of the operation unit 219.

A printer I/F 216 connects between a printer 220 and the control unit 210. An image file to be printed by the printer 220 is transferred from the control unit 210 via the printer I/F 216, and is printed on a storage medium such as a paper sheet by the printer 220. A scanner I/F 217 connects between a scanner 221 and the control unit 210. The scanner 221 scans an image on a document to generate an image file, and inputs the image file to the control unit 210 via the scanner I/F 217. A network I/F 218 connects the control unit 210 (image processing apparatus 101) to the LAN 110. The network I/F 218 transmits an image file and information to an external apparatus (for example, a Web server) on the LAN 110, and receives various kinds of information from the external apparatus on the LAN 110.

(Microblog Service Server)

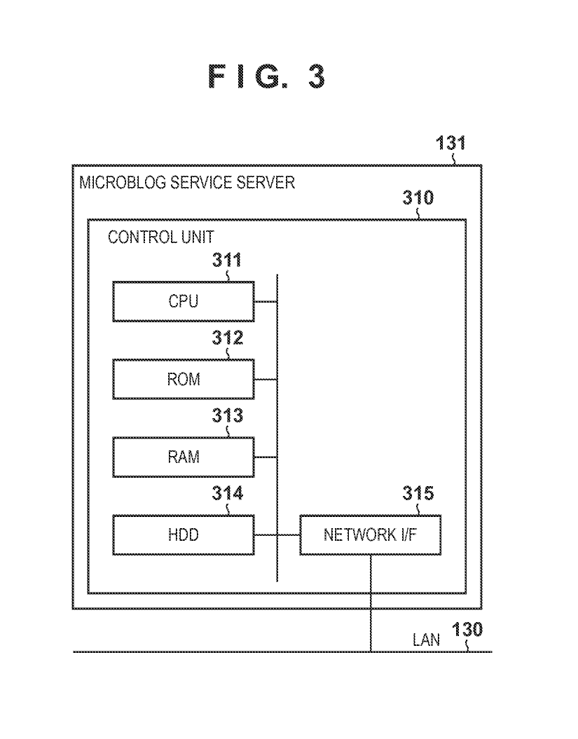

FIG. 3 is a block diagram showing the arrangement of the microblog service server 131 to which the present invention is applicable. A control unit 310 including a CPU 311 controls the operations of the overall microblog service server 131. The CPU 311 executes various kinds of control processing by reading out control programs stored in a ROM 312. A RAM 313 is used as temporary storage areas such as a main memory and work area of the CPU 311. An HDD 314 stores image files, various programs, or various information tables (to be described later). A network I/F 315 connects the control unit 310 (microblog service server 131) to a LAN 130. The network I/F 315 exchanges various kinds of information between other apparatuses on the LANs 110 and 130. Note that the arrangement of a general information processing apparatus is applicable to that of the microblog service server 131.

(Microblog Cooperative Service Server)

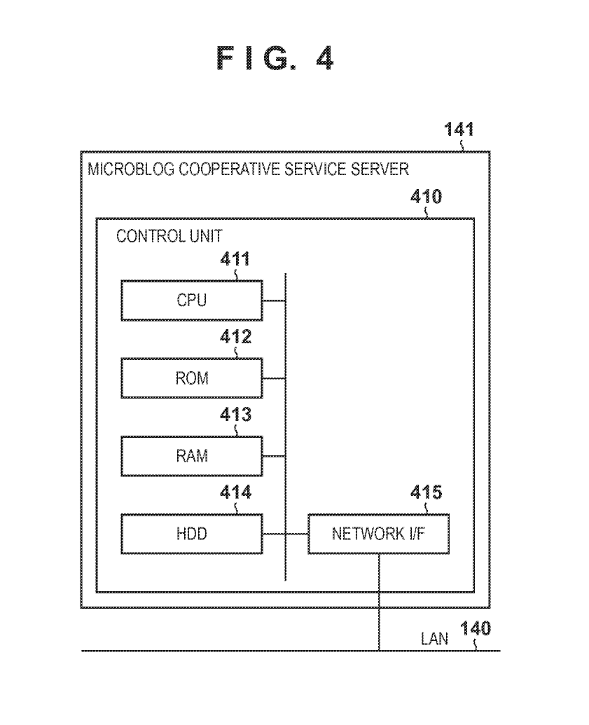

FIG. 4 is a block diagram showing the arrangement of the microblog cooperative service server 141. Since this arrangement is the same as that of the microblog service server 131 described using FIG. 3, a detailed description thereof will not be given.

[Software Configuration]

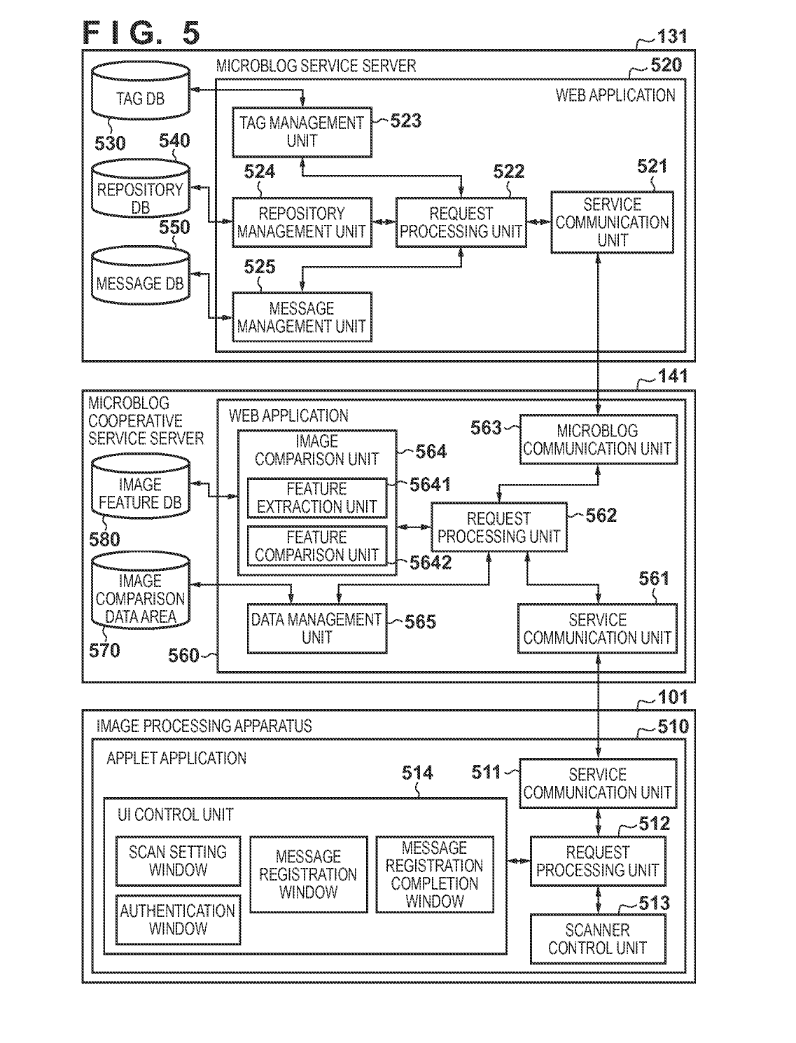

FIG. 5 is a block diagram for explaining software configurations of the image processing apparatus 101, microblog service server 131, and microblog cooperative service server 141.

The image processing apparatus 101 includes an applet application 510. Furthermore, the applet application 510 includes a service communication unit 511, request processing unit 512, scanner control unit 513, and UI control unit 514. The applet application 510 displays a UI (User Interface) on the operation unit 219 of the image processing apparatus 101, and communicates with the microblog cooperative service server 141 according to the input contents.

The service communication unit 511 receives a communication request from the request processing unit 512, and communicates with the microblog cooperative service server 141. Request contents at that time include authentication processing with the microblog service server, upload of scan data, and the like. Also, the service communication unit 511 analyzes a response from a service communication unit 561, and transmits a request result to the request processing unit 512. Assume that the service communication unit 511 controls communication processes in different application layers for respective services. For example, the service communication unit 511 executes communication processes with services implemented by Web services such as SOAP (Simple Object Access Protocol) and REST (REpresentational State Transfer) implemented using HTTP or the like as a communication protocol. Thus, the image processing apparatus 101 can use services provided by a Web server.

The request processing unit 512 requests the service communication unit 511 to communicate with the microblog cooperative service server 141 based on user input information received from the UI control unit 514, and executes various kinds of processing based on the communication result. For example, when authentication information input by the user via an authentication window of the UI control unit 514 is received, the request processing unit 512 requests the service communication unit 511 to make an authentication communication. When response contents to that request indicate that authentication has succeeded, the request processing unit 512 requests the UI control unit 514 to display a scan setting window.

The scanner control unit 513 acquires scan settings from the request processing unit 512, requests the scanner 221 to scan an image based on the settings, and executes file conversion of scan data. Upon completion of file conversion, the scanner control unit 513 transmits the scan data to the request processing unit 512.

The UI control unit 514 sets a UI to be displayed on the operation unit 219 of the image processing apparatus 101 in response to a UI display request from the request processing unit 512. Also, the UI control unit 514 acquires information input by the user on the operation unit 219, and transmits the acquired information to the request processing unit 512.

The microblog service server 131 includes a Web application 520, tag database 530, repository database 540, and message database 550. Furthermore, the Web application 520 includes a service communication unit 521, request processing unit 522, tag management unit 523, repository management unit 524, and message management unit 525. The tag database 530, repository database 540, and message database 550 will be respectively abbreviated as the tag DB 530, repository DB 540, and message DB 550 hereinafter.

The Web application 520 is required to provide CRM services and the like. In this embodiment, assume that the Web application 520 provides the microblog function.

The service communication unit 521 receives requests from the microblog cooperative service server 141 and terminal 102, and transmits request contents to the request processing unit 522. Also, the service communication unit 521 receives request processing results from the request processing unit 522, and transmits them as response information to the microblog cooperative service server 141 and the terminal 102 such as a PC.

The request processing unit 522 receives a request transmitted from the service communication unit 521, registers a message, and acquires information associated with the message. Message registration is executed as follows.

The request processing unit 522 analyzes a request transmitted from the service communication unit 521, extracts contents of a message to be registered and information of a registered user, and requests the message management unit 525 to register the message. In this case, the registered message is assigned a unique identifier (ID). This unique ID for the message will be described as a message ID hereinafter. When an image file is attached to the request, the request processing unit 522 requests the repository management unit 524 to register the attached image file, corresponding unit message ID, and registered user in association with each other. Also, when a tag registration request is included, the request processing unit 522 requests the tag management unit 523 to register a tag and the corresponding message ID in association with each other.

Also, the service communication unit 521 may request the request processing unit 522 to add a comment to a message in place of message registration. In this case, the request processing unit 522 requests the message management unit 525 to add a comment to the message corresponding to the message ID. When a comment requests to register a tag, the request processing unit 522 requests the tag management unit 523 to register the tag and corresponding message ID in association with each other. Acquisition of information associated with the message is executed as follows.

The request processing unit 522 analyzes a request received from the service communication unit 521, and settles a search condition of message information to be acquired. The request processing unit 522 requests the respective functional units to search for messages and data files using the message ID and information of the registered user as keys, and transmits a search result to the service communication unit 521. For example, when the service communication unit 521 requests the request processing unit 522 to acquire message contents corresponding to a specific message ID, the request processing unit 522 requests the message management unit 525 to acquire corresponding message contents.

The tag management unit 523 receives tag information and a corresponding message ID transmitted from the request processing unit 522, and registers the tag information in the tag DB 530. Also, when a tag information search request is received from the request processing unit 522, the tag management unit 523 transmits all pieces of tag information corresponding to the transmitted message ID to the request processing unit 522.

The repository management unit 524 receives an image file, corresponding message ID, and registered user information transmitted from the request processing unit 522, and registers the image file in the repository DB 540. In this case, an image file ID required to uniquely identify that image file is issued as in the message ID. When the repository management unit 524 receives an image file search request from the request processing unit 522, it acquires image file IDs corresponding to the message ID or registered user information from the repository DB 540. Then, the repository management unit 524 transmits all pieces of acquired information to the request processing unit 522. The repository management unit 524 receives an acquisition request of an image file corresponding to an image file ID, acquires corresponding image file data from the repository DB 540, and transmits the acquired data to the request processing unit 522.

The message management unit 525 stores a message received from the request processing unit 522 in the message DB 550. In this case, the message management unit 525 also stores a message ID issued upon reception of that message in the message DB 550, and further transmits that information to the request processing unit 522. When a comment is added, the message management unit 525 adds the comment to a message corresponding to a message ID to the message DB 550. Upon reception of a message acquisition request from the request processing unit 522, the message management unit 525 acquires a corresponding message from the message DB 550 using a message ID as a key. Then, the message management unit 525 transmits message information to the request processing unit 522.

The tag DB 530 registers tag information and a corresponding message ID transmitted from the tag management unit 523 in association with each other, as described above. Upon reception of a tag information acquisition request from the tag management unit 523, the tag DB 530 provides tag information corresponding to a message ID.

The repository DB 540 registers an image file, corresponding message ID, and registered user information transmitted from the repository management unit 524 in association with each other, as described above. Also, upon reception of an image file acquisition request from the repository management unit 524, the repository DB 540 provides an image file corresponding to a message ID or registered user information.

The message DB 550 registers message contents and a message ID transmitted from the message management unit 525 in association with each other, as described above. Upon reception of a comment addition request, the message DB 550 registers a comment in association with the corresponding message ID. Also, upon reception of a message content acquisition request from the message management unit 525, the message DB 550 provides message contents corresponding to a message ID to the message management unit 525.

The microblog cooperative service server 141 includes a Web application 560, image comparison data area 570, and image feature database 580. Furthermore, the Web application 560 includes a service communication unit 561, request processing unit 562, microblog communication unit 563, image comparison unit 564, and data management unit 565. The image feature database 580 will be abbreviated as the image feature DB 580 hereinafter.

The Web application 560 communicates with both the image processing apparatus 101 and microblog service server 131. With this communication, the image processing apparatus 101 can use the functions of the microblog service server 131 via the microblog cooperative service server 141.

The service communication unit 561 receives various requests from the service communication unit 511 of the image processing apparatus 101 to the microblog service server 131, and requests the request processing unit 562 to execute processes. Also, the service communication unit 561 transmits processing results received from the request processing unit 562 to the service communication unit 511 of the image processing apparatus 101 as response information.

The request processing unit 562 receives the requests from the service communication unit 561 and those from the microblog communication unit 563, and requests the respective units to execute processes. For example, upon reception of a communication request to the microblog service server 131 from the service communication unit 561, the request processing unit 562 requests the microblog communication unit 563 to execute communication processing. Also, upon reception of an image file storage request from the service communication unit 561 or microblog communication unit 563, the request processing unit 562 requests the data management unit 565 to store an image file. On the other hand, when a similar image search is required, the request processing unit 562 requests the image comparison unit 564 to compare image files.

Upon reception of various communication requests to the microblog service server 131 from the request processing unit 562, the microblog communication unit 563 communicates with the microblog service server 131. Also, the microblog communication unit 563 transmits a communication result with the microblog service server 131 to the request processing unit 562.

Upon reception of a comparison request of image files from the request processing unit 562, the image comparison unit 564 executes similarity comparison between two or more image files. Initially, a feature extraction unit 5641 of the image comparison unit 564 analyzes image files to extract image feature data used as similarity determination criteria between images. Next, the image comparison unit 564 stores the extracted image feature data in the image feature DB 580. Various feature extraction methods effective for a similar image search are applicable. Methods which can be adopted include, for example, the following methods.

As an example of a feature extraction method, a method of extracting objects from edges and the like in an image to determine object shapes, and using shapes, layouts, colors, a positional relationship between a plurality of objects, and the like is available. Also, a method of extracting a dominant color combination or color pattern in an entire image as a histogram and the like is available. However, the present specification does not particularly limit the feature extraction method, and the following description will be given using an arbitrary conventional method. Also, data extracted by the feature extraction processing will be collectively described as image feature data hereinafter. Also, in the present specification, the feature extraction processing is executed for image data. However, the present invention is not limited to this, and features may be extracted by comparing, for example, character strings and the like.

A feature comparison unit 5642 of the image comparison unit 564 acquires values of the respective image feature data stored in the image feature DB 580 by the feature extraction unit 5641. Initially, the feature comparison unit 5642 acquires image feature data of an image file as a comparison source from the image feature DB 580. Next, the feature comparison unit 5642 acquires image feature data of an image file as a comparison target from the image feature DB 580, and compares the acquired data with the image feature data of the image file as the comparison source. As a result, when the feature comparison unit 5642 judges that a difference between the image feature data of the two image files falls within a determined criterion range, the image comparison unit 564 transmits a result indicating that the two image files are similar images to the request processing unit 562. When the difference between the image feature data of the two image files falls outside the determination criterion range, the image comparison unit 564 transmits a result indicating that the two image files are non-similar images to the request processing unit 562. Also, the request processing unit 562 may designate a reference value of similar image comparison. Assume that similar/non-similar determination criteria are defined in advance.

The data management unit 565 receives an image file storage request from the request processing unit 562, and stores an image file in the image comparison data area 570. Upon reception of an image file acquisition request from the request processing unit 562, the data management unit 565 acquires an image file from the image comparison data area 570, and transmits the acquired image file to the request processing unit 562.

The image comparison data area 570 is used to store image files which are to undergo a similar image search, as described above, and those to be uploaded to the microblog service server 131. The image comparison data area 570 stores and provides image files according to storage and acquisition requests from the data management unit 565.

The image feature DB 580 stores image feature data of image files extracted by the feature extraction unit 5641 of the image comparison unit 564, as described above. The image feature DB 580 stores and provides image feature data according to image feature data storage and acquisition requests from the image comparison unit 564.

[User Interface]

(Authentication Window)

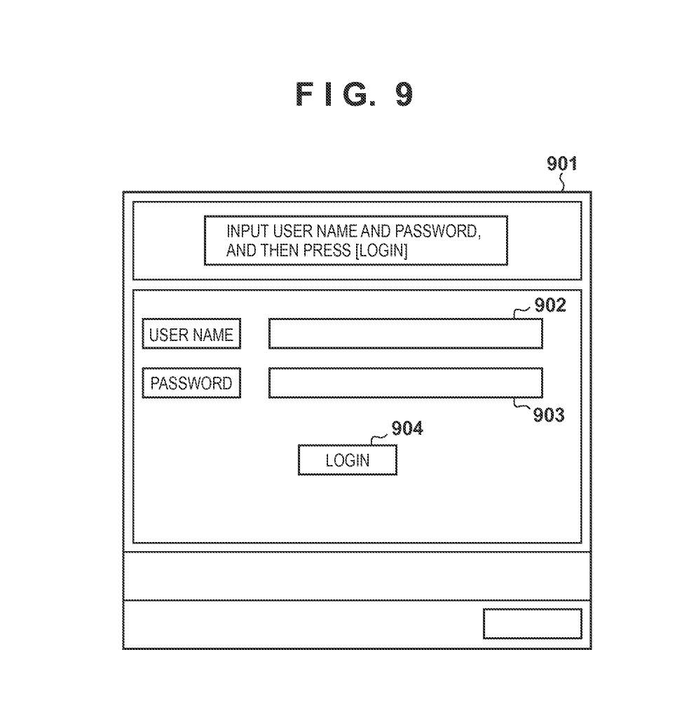

FIG. 9 shows an authentication window 901 of the applet application 510 of the image processing apparatus 101 according to the embodiment of the present invention.

A window is displayed on a contents display area based on a response received from the microblog cooperative service server 141. FIG. 9 shows a display result of an authentication window on the operation unit 219 of the image processing apparatus 101 when the request processing unit 512 requests the UI control unit 514 to display the authentication window.

The user of the image processing apparatus 101 inputs a user name to a user name input field 902. The user of the image processing apparatus 101 inputs a password to a password input field 903. When the user presses a login button 904, the values input to the user name input field 902 and password input field 903 are transmitted to the microblog cooperative service server 141 as an authentication request.

(Scan Setting Window)

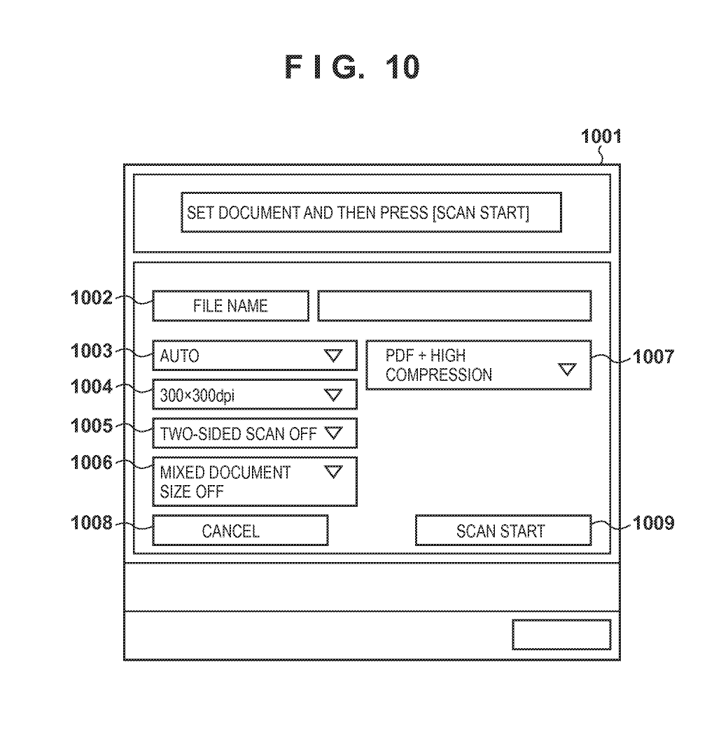

FIG. 10 shows a scan setting window 1001 of the applet application 510 of the image processing apparatus 101 according to the embodiment of the present invention.

A window is displayed on the contents display area based on a response received from the microblog cooperative service server 141. FIG. 10 shows a display result of a scan setting window on the operation unit 219 of the image processing apparatus 101 when the request processing unit 512 requests the UI control unit 514 to display the scan setting window.

The user of the image processing apparatus 101 inputs a file name to a file name input field 1002, thereby setting an image file name to be attached to a message of the microblog service server 131. A display area includes a color selection button 1003, resolution selection button 1004, two-sided scanning face selection button 1005, mixed original size selection button 1006, file format selection button 1007, cancel button 1008, and scan start button 1009. Upon pressing of the respective scan setting buttons 1003 to 1007, setting values selectable as scan settings are respectively displayed in a list form, and the user can designate scan settings from these lists. Upon pressing of the cancel button 1008, the scan setting window is closed, thus canceling scan upload processing. Upon pressing of the scan start button 1009, scan settings set using the file name input field 1002 and the scan setting buttons 1003 to 1007 are acquired. After scan processing is executed, scan data is uploaded to the microblog cooperative service server 141.

(Message Registration Window)

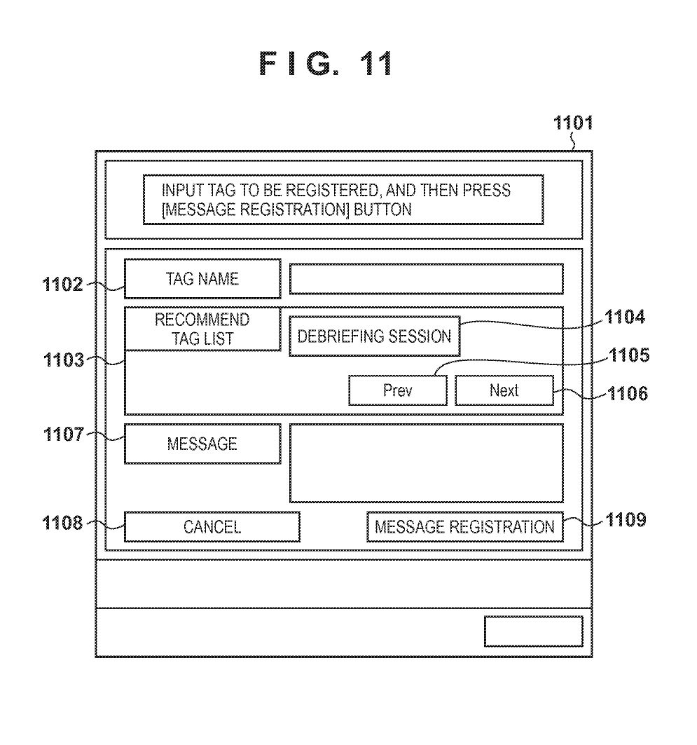

FIG. 11 shows a message registration window 1101 of the applet application 510 of the image processing apparatus 101 according to the first embodiment of the present invention.

A window is displayed on the contents display area based on a response received from the microblog cooperative service server 141. FIG. 11 shows a display result of a message registration window on the operation unit 219 of the image processing apparatus 101 when the request processing unit 512 requests the UI control unit 514 to display the message registration window.

The user of the image processing apparatus 101 inputs a tag name to a tag name input field 1102, thereby designating a tag name to be registered in a message of the microblog service server 131.

A recommend tag button display area 1103 displays a recommend tag button 1104 of a tag to be registered. Note that there are a plurality of recommend tag buttons 1104, which may not be displayed within the recommend tag button display area 1103. In this case, recommend tag buttons 1104 which fall outside the recommend tag button display area 1103 are not displayed, but these recommend tag buttons 1104 are displayed in turn when the user presses a Next button 1106. In this case, the recommend tag buttons 1104, which were displayed so far, are no longer displayed, but are re-displayed in turn when the user presses a Prev button 1105.

Upon pressing of the recommend tag button 1104, a tag name corresponding to the pressed recommend tag button 1104 is input to the tag name input field 1102. In this example, upon pressing of the recommend tag button 1104, a tag name “debriefing session” is input to the tag name input field 1102.

Upon pressing of the Prev button 1105, the recommend tag button display area 1103 is updated to the immediately preceding state, as described above. Upon pressing of the Next button 1106, recommend tag buttons 1104, which fall outside the recommend tag button display area 1103, are displayed on the recommend tag button display area 1103, as described above.

The user of the image processing apparatus 101 inputs a character string as contents of a message to a message input field 1107, thereby designating message contents to be registered in the microblog service server 131.

Upon pressing of a cancel button 1108, the message registration window 1101 is closed, thus canceling message registration processing.

Upon pressing of a message registration button 1109, the input values of the tag name input field 1102 and message input field 1107 are acquired. Then, the designated tag name and message contents are transmitted to the microblog cooperative service server 141.

This message registration window 1101 implements a receiving unit.

(Message Registration Completion Window)

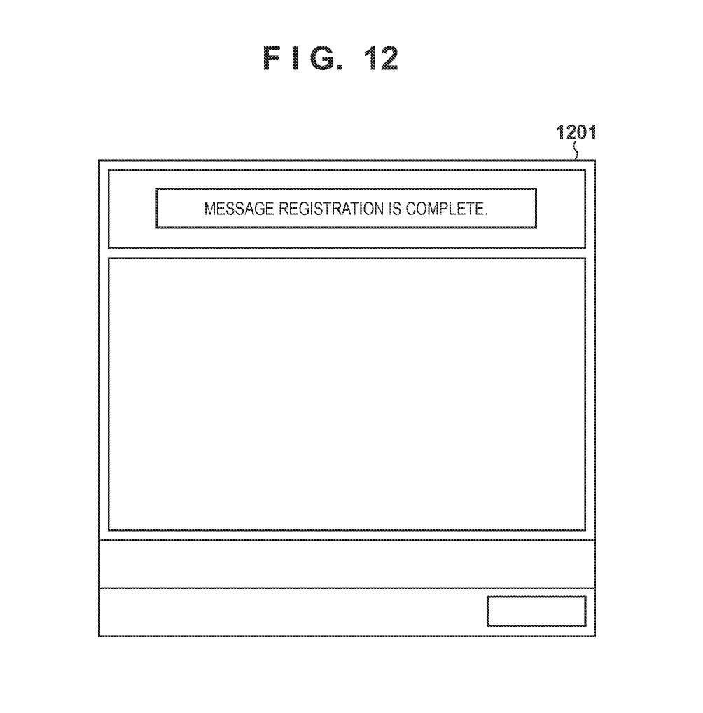

FIG. 12 shows a message registration completion window 1201 of the applet application 510 of the image processing apparatus 101 according to the embodiment of the present invention.

A window is displayed on the contents display area based on a response received from the microblog cooperative service server 141. FIG. 12 shows a display result of a message registration completion window on the operation unit 219 of the image processing apparatus 101 when the request processing unit 512 requests the UI control unit 514 to display the message registration completion window.

(Microblog Function Window)

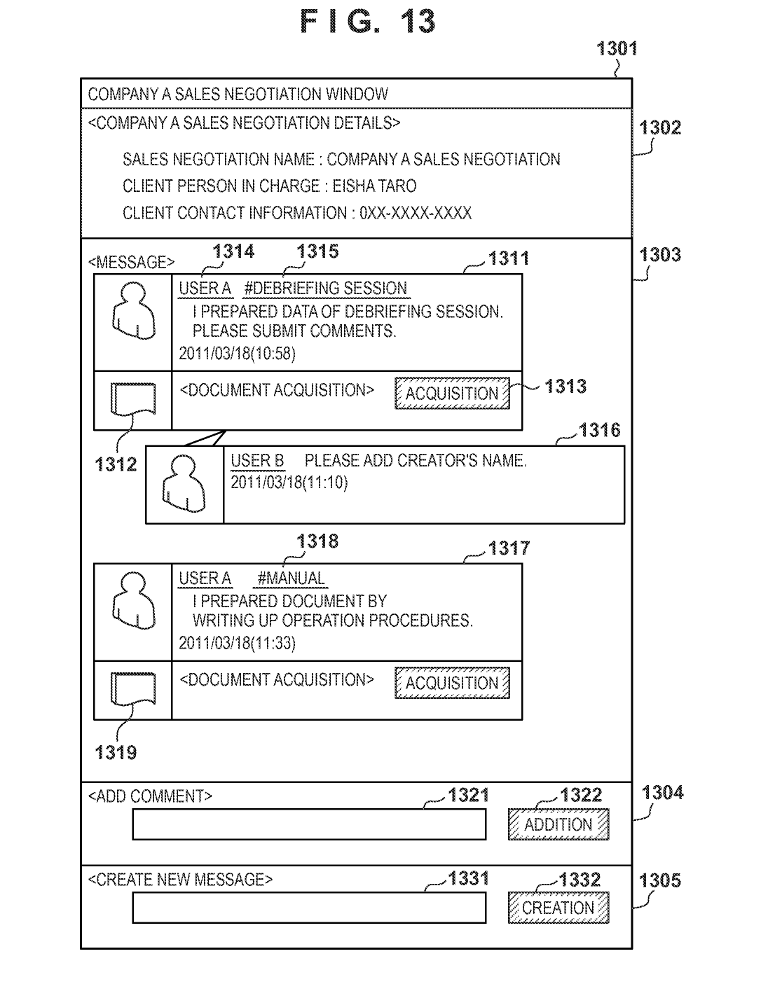

FIG. 13 is a view for explaining microblog function provided by the microblog service server 131 to which the present invention is applicable. FIG. 13 shows a display example of a Web page displayed when the user accesses from a Web browser which runs on the terminal 102 to the microblog service server 131. Assume that the microblog service server 131 manages messages and comments for sales negotiation information which is currently in progress for the purpose of sharing information for a specific sales negotiation.

A company A sales negotiation window 1301 displays information related to a sales negotiation with company A. A sales negotiation detail area 1302 displays a sales negotiation name, client person in charge, client contact information, and the like as information related to the sales negotiation.

A message display area 1303 displays timelines including messages and comments for the messages. The message display area 1303 displays a state in which the user A registers a message 1311 “I prepared data of the debriefing session. Please input comments.” and an image file 1312. A comment 1316 is that for the message 1311. The message display area 1303 displays a state in which a user B replies the comment 1316 “Please add creator's name.” to the message 1311. An acquisition button 1313 is used to instruct to acquire the registered image file 1312. When the user presses the acquisition button 1313, the Web browser transmits an image file acquisition request to the microblog service server 131, and the user can acquire the image file 1312.

A user name 1314 in the message 1311 displays a user name who registers that message. Also, the user name 1314 also serves as a hyperlink to a Web page of search results of messages or comments using that user name as a keyword. A tag 1315 in the message 1311 is displayed in a format which appends a tag character string to # (sharp sign). Furthermore, the tag 1315 also serves as a hyperlink to a Web page of search results of messages or comments using that tag information as a keyword. A user name and tag information like the user name 1314 and tag 1315 are also displayed in the comment.

In the message display area 1303, the user A also registers a message 1317 “I prepared a document by writing up operation procedures” and an image file 1319. The message 1317 is a message in the same manner as the message 1311, but as can be seen from the message contents, it is a message of a matter different from the message 1311. For this reason, the messages 1311 and 1317 are not related, and tag information different from the tag 1315 is registered in the tag 1318. Likewise, the image file 1319 is different from the image file 1312.

In a comment input area 1304, when the user inputs character string information as comment contents in a comment input box 1321 and presses an addition button 1322, the Web browser transmits a comment addition request to the microblog service server 131. Upon reception of the comment addition request, the microblog service server 131 registers the input character string information as a comment. With this operation, when the user accesses the microblog service server 131 using the Web browser, the registered comment is displayed on the Web browser like the aforementioned comment 1316.

In a message input area 1305, when the user inputs character string information as a message in a message input box 1331 and presses a creation button 1332, the Web browser transmits a message creation request to the microblog service server 131. Upon reception of the message creation request, the microblog service server 131 registers the input character string information as a message. With this operation, when the user accesses the microblog service server 131 using the Web browser, the created message is displayed on the Web browser like the aforementioned messages 1311 and 1317.

(Display Example of Image File)

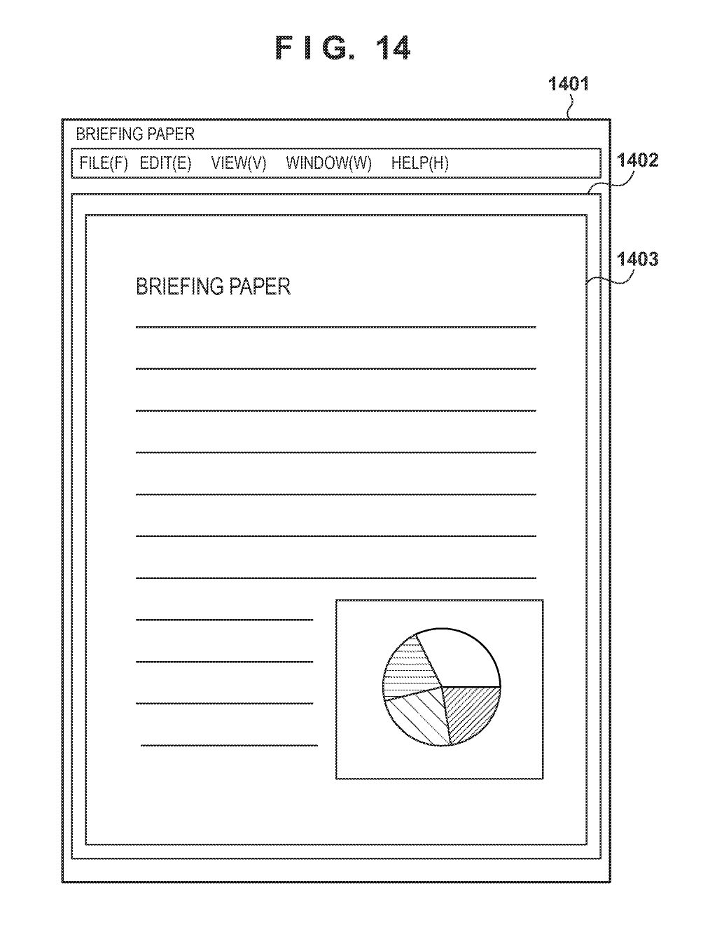

FIG. 14 shows the image file 1312 as a display example of the image file acquired from the microblog service server 131. A window 1401 indicates the entire display window of the terminal 102, and includes a layout display window 1402. The layout display window 1402 displays an image 1403 according to the contents of the image file.

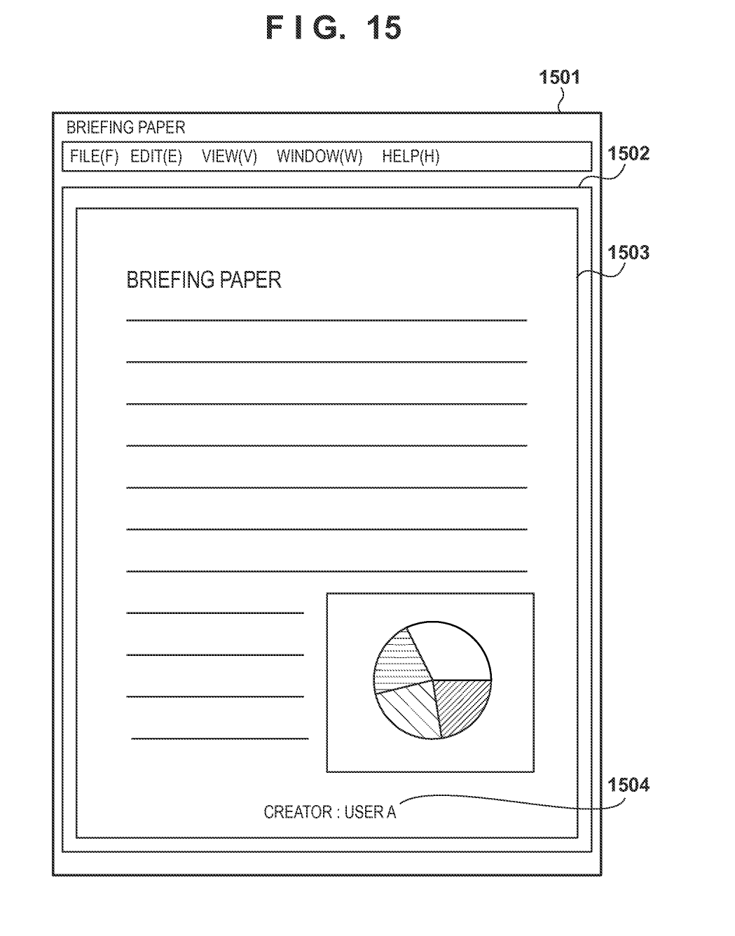

FIG. 15 shows, as a display example of the image file acquired from the microblog service server 131, an image file obtained by modifying the image file 1312 of the user A in response to the comment 1316 of the user B. A window 1501 indicates the entire display window of the terminal 102, and includes a layout display window 1502. The layout display window 1502 displays an image 1503 according to the contents of the image file. A description 1504 is a part modified by the user A in response to the comment “I hope for addition of the creator's name” from the user B, and describes the name of the user A.

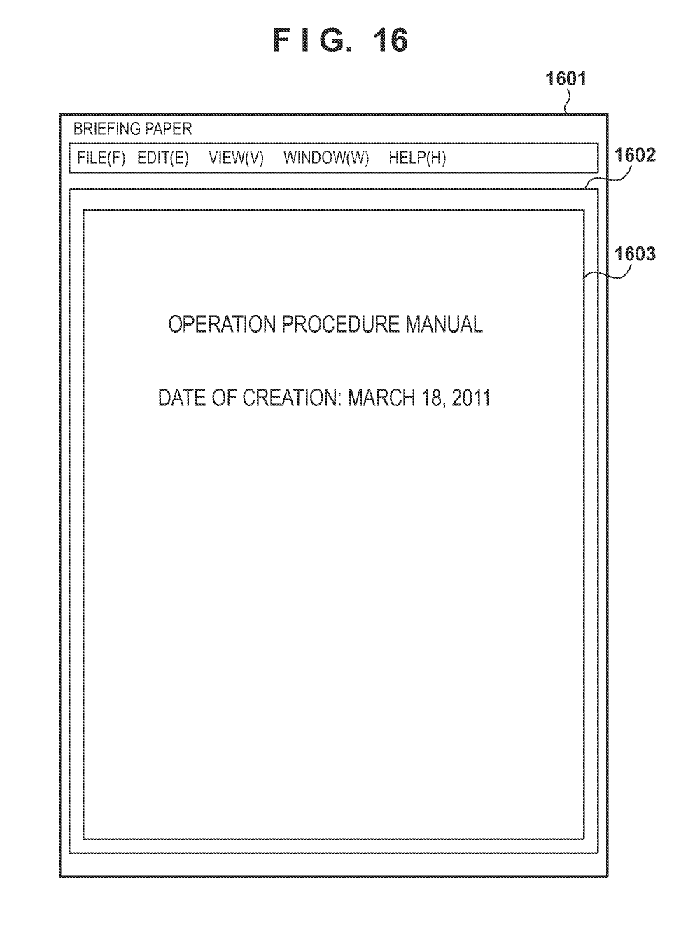

FIG. 16 shows the image file 1319 as a display example of the image file acquired from the microblog service server 131. A window 1601 indicates the entire display window of the terminal 102, and includes a layout display window 1602. The layout display window 1602 displays an image 1603 according to the contents of the image file.

[Sequence Chart]

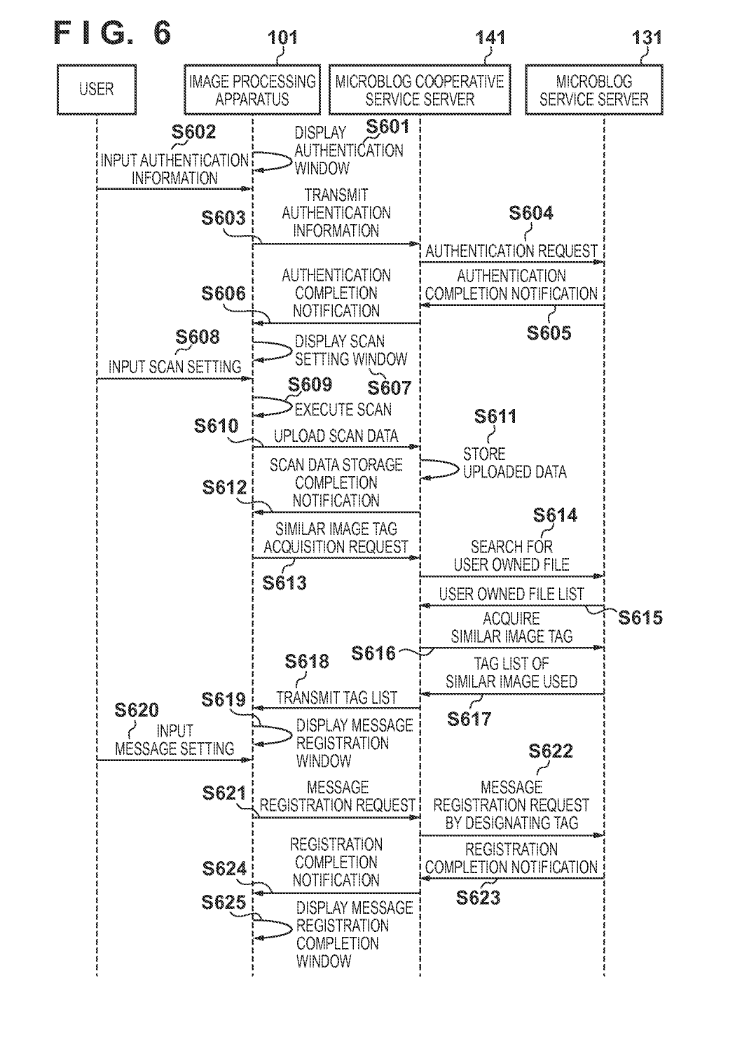

FIG. 6 is a sequence chart for explaining operations required to execute a series of processes of the user of the image processing apparatus 101, the image processing apparatus 101, the microblog cooperative service server 141, and the microblog service server 131 in this embodiment. Note that the user of the image processing apparatus 101 is the user A in FIG. 13 for the sake of simplicity, and will be described as the user A hereinafter. Also, assume that in this embodiment, the processing of the following sequence is executed in the window state shown in FIG. 13.

In step S601, the request processing unit 512 of the applet application 510 renders the authentication window 901 shown in FIG. 9 on the operation unit 219.

In step S602, the user A inputs a user name and password in the user name input field 902 and password input field 903 in the authentication window 901, and presses the login button 904.

In step S603, the request processing unit 512 of the applet application 510 transmits the user name and password input by the user to the service communication unit 511. The service communication unit 511 requests the service communication unit 561 of the microblog cooperative service server 141 to execute authentication with the microblog service server 131.

In step S604, upon reception of the authentication request from the service communication unit 511 of the applet application 510, the service communication unit 561 of the microblog cooperative service server 141 transmits the authentication information to the request processing unit 562. The request processing unit 562 transmits an authentication request to the microblog communication unit 563. The microblog communication unit 563 communicates with the service communication unit 521 of the microblog service server 131 to request it to authenticate the user A.

In step S605, upon reception of the authentication request from the microblog cooperative service server 141, the service communication unit 521 of the microblog service server 131 requests the request processing unit 522 to execute authentication processing. The request processing unit 522 transmits a received authentication result to the service communication unit 521. The service communication unit 521 transmits the authentication result to the service communication unit 561 of the microblog cooperative service server 141 as response information.

In step S606, the microblog communication unit 563 of the microblog cooperative service server 141 receives the authentication result of the user A from the service communication unit 521, and transmits that result to the request processing unit 562. The request processing unit 562 transmits the authentication result of the user A to the service communication unit 561. The service communication unit 561 transmits the authentication result of the user A to the image processing apparatus 101 as response information.

In step S607, the service communication unit 511 of the image processing apparatus 101 receives the authentication result of the user A from the microblog cooperative service server 141, and transmits that result to the request processing unit 512. The request processing unit 512 analyzes the authentication result of the user A. When the authentication has succeeded, the request processing unit 512 renders the scan setting window 1001 shown in FIG. 10 on the operation unit 219. On the other hand, when the authentication has failed, the request processing unit 512 notifies the user A of an authentication error, and prompts the user to re-input authentication information.

In step S608, the user A inputs an image file name to be attached to a message and scan settings on the scan setting window 1001 displayed on the operation unit 219, and presses the scan start button 1009. At this time, assume that the user A sets an image after modification on the scanner 221 of the image processing apparatus 101.

In step S609, the request processing unit 512 of the image processing apparatus 101 transmits the scan settings input by the user A to the scanner control unit 513 to request the scanner 221 to execute scan processing. The scanner 221 scans the image modified by the user A based on the received scan settings, and executes file conversion of scan data. In this case, assume that the file-converted image file (data file) has the contents shown in FIG. 15, and will be defined as “image file A” hereinafter.

In step S610, the request processing unit 512 receives the file-converted image file A from the scanner control unit 513, and requests the service communication unit 511 to upload that file to the microblog cooperative service server 141. The service communication unit 511 uploads the image file A by communicating with the service communication unit 561 of the microblog cooperative service server 141.

In step S611, the service communication unit 561 of the microblog cooperative service server 141 receives the image file A from the service communication unit 511 of the image processing apparatus 101, and transmits the image file A to the request processing unit 562. The request processing unit 562 requests the data management unit 565 to store the image file A. The data management unit 565 stores the image file A in the image comparison data area 570.

In step S612, the request processing unit 562 of the microblog cooperative service server 141 receives a storage completion notification of the image file A from the data management unit 565, and transmits the storage completion notification to the service communication unit 561. The service communication unit 561 transmits the storage completion notification of the image file A to the image processing apparatus 101 as response information.

In step S613, the service communication unit 511 of the image processing apparatus 101 requests the service communication unit 561 of the microblog cooperative service server 141 to acquire a tag list (not shown) registered in a message with an attached image file similar to the image file A. The tag list will be described later. The image file A to be currently uploaded is obtained by slightly modifying the contents of the image file 1312. That is, the contents of the image file 1312 shown in FIG. 14 are modified to those shown in FIG. 15. For this reason, it is desirable to acquire the tag 1315 “debriefing session” registered in the message 1311 corresponding to the image file 1312.

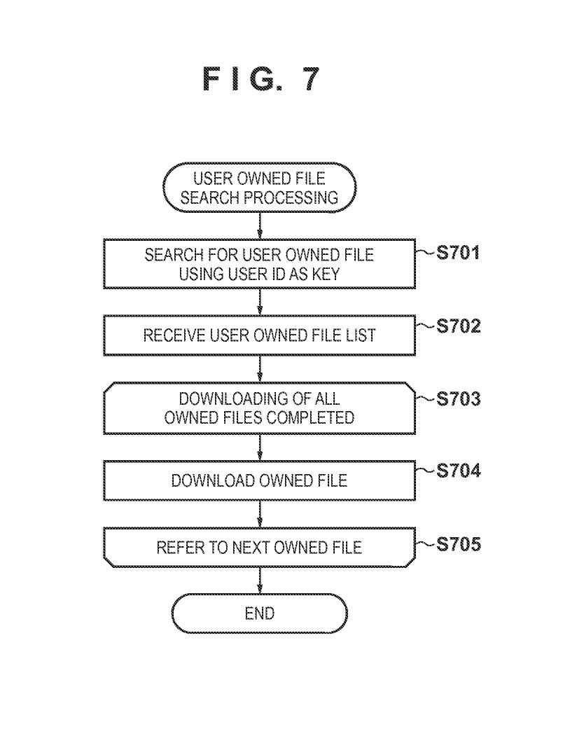

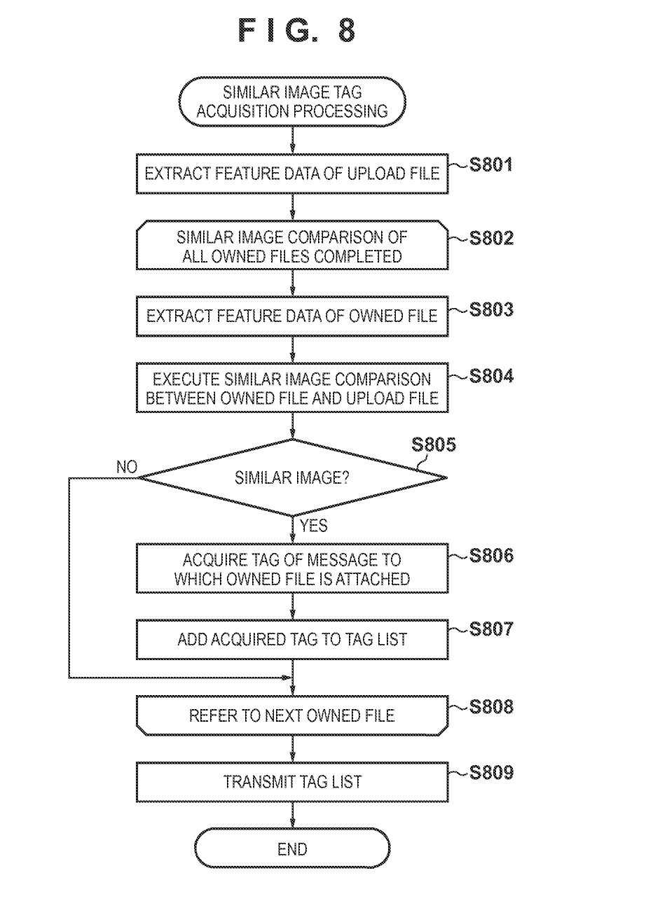

In steps S614 to S617 in FIG. 6, acquisition processing of tag information registered in a message attached with a similar image to the image file A is executed. This processing will be described in detail below with reference to FIGS. 7 and 8.

(User Owned File Search Processing)

FIG. 7 is a flowchart for explaining the operation of user owned file search processing by the Web application 520 of the microblog cooperative service server 141 according to the first embodiment of the present invention. This processing sequence is implemented when the CPU of the microblog cooperative service server 141 reads out a program stored in the HDD or the like as a storage unit onto the RAM, and executes the readout program.

In step S701, upon reception of a tag acquisition request from the service communication unit 511, the service communication unit 561 of the microblog cooperative service server 141 transmits the tag acquisition request to the request processing unit 562. Upon reception of the tag acquisition request, the request processing unit 562 requests the microblog communication unit 563 to acquire a list of image files owned by the user A (to be referred to as a user owned file list hereinafter). The user owned file list stores image file IDs corresponding to image files owned by the user A. The microblog communication unit 563 requests the service communication unit 521 of the microblog service server 131 to acquire the user owned file list corresponding to the user A. In response to this request, the microblog service server 131 transmits IDs of all image files owned by the user A, which are stored in the repository DB 540, based on the user ID of the user A to the microblog communication unit 563 as response information.

In step S702, the microblog communication unit 563 receives the user owned file list corresponding to the user A from the microblog service server 131, and transmits that list to the request processing unit 562.

Step S703 is a loop end, and the request processing unit 562 repeats a loop of steps S703 to S705 until all owned files of the user A are downloaded according to the received user owned file list.

In step S704, the request processing unit 562 refers to the user owned file list corresponding to the user A, and requests the microblog communication unit 563 to download an image file corresponding to an image file ID. The microblog communication unit 563 communicates with the microblog service server 131 to download the corresponding image file from the repository DB 540 of the microblog service server 131, and transmits that image file to the request processing unit 562. The request processing unit 562 requests the data management unit 565 to store the downloaded image file. The data management unit 565 stores the downloaded image file in the image comparison data area 570. By repeating these operations, all the image files owned by the user A can be stored in the image comparison data area 570. For example, in the example of FIG. 13, since the image files 1312 and 1319 are image files owned by the user A, these image files 1312 and 1319 are stored in the image comparison data area 570.

Step S705 is a loop end, and the request processing unit 562 refers to the next owned file of the user owned file list corresponding to the user A to return the process to step S703.

The image files owned by the user A are stored in the image comparison data area 570 according to the flowchart shown in FIG. 7.

(Similar Image Comparison Processing and Tag List Acquisition Processing)

Next, according to the flowchart shown in FIG. 8, the image files owned by the user A and the image file

A uploaded in step S610 undergo similar image comparison processing to acquire a tag list. Note that the tag list is a list required to indicate tags included in messages, and is recorded in an HDD or the like. Also, the tag list may be initialized before the beginning of this processing sequence.

FIG. 8 is a flowchart for explaining the operation of similar image comparison processing and tag list acquisition processing by the microblog cooperative service server 141 according to the first embodiment of the present invention. This processing sequence is implemented when the CPU of the microblog cooperative service server 141 reads out a program stored in the HDD or the like as a storage unit onto the RAM, and executes the readout program.

In step S801, the request processing unit 562 of the microblog cooperative service server 141 requests the image comparison unit 564 to extract image feature data of the image file A stored in the image comparison data area 570 in step S611. The feature extraction unit 5641 of the image comparison unit 564 extracts image feature data of the image file A, and stores the extracted data in the image feature DB 580.

Step S802 is a loop end, and the request processing unit 562 repeats a loop until similar image comparison processing between the image file A and all the image files owned by the user A, which are stored in the image comparison data area 570, is complete.

In step S803, the request processing unit 562 requests the data management unit 565 to acquire the image file owned by the user A, which is stored in the image comparison data area 570 in step S703. Then, the request processing unit 562 requests the image comparison unit 564 to extract image feature data of the image file acquired via the data management unit 565. The feature extraction unit 5641 of the image comparison unit 564 extracts image feature data of that image file, and stores the extracted data in the image feature DB 580. In the example of FIG. 13, the image feature data of the image files 1312 and 1319 are stored in the image feature DB 580.

In step S804, the request processing unit 562 requests the image comparison unit 564 to execute similar image comparison processing between the image file A and the image file owned by the user A. The feature comparison unit 5642 of the image comparison unit 564 refers to the image feature data of the image file A and those of the image file owned by the user A, which are stored in the image feature DB 580, thus comparing these files. The image comparison unit 564 transmits a comparison result to the request processing unit 562. In the example of FIG. 13, the image feature data of the image files 1312 and 1319 and those of the image file A are compared.

The request processing unit 562 judges in step S805 whether or not the image file A and the user owned image file are similar images. In this case, if the request processing unit 562 judges that these files are not similar images (NO in step S805), processes of steps S806 and S807 are skipped. In the example of FIG. 13, assume that the image file 1312 is judged as a similar image since it is a file before slight modification of the image file A. On the other hand, assume that the image file 1319 is judged as a non-similar image since it is not related to the image file A.

Step S806 is processing executed when the request processing unit 562 judges in step S805 that the image file owned by the user A is a similar image of the image file A. In step S806, the request processing unit 562 requests the microblog communication unit 563 to acquire a message ID to which the similar image is attached, so as to acquire a tag of a message to which the similar image file is attached. The microblog communication unit 563 communicates with the microblog service server 131 to acquire the message ID to which the similar image file is attached from the message DB 550. In the example of FIG. 13, since the similar image file is the image file 1312, the message ID to be acquired is that of the message 1311. In this example, only one message ID is to be acquired. However, if there is a plurality of similar images, all corresponding message IDs are acquired.

A list of the message ID acquired in this step is transmitted to the request processing unit 562. Then, the request processing unit 562 requests the microblog communication unit 563 to acquire a tag registered in each message. The microblog communication unit 563 communicates with the microblog service server 131 to acquire a tag registered in the message corresponding to the message ID from the tag DB 530. In the example of FIG. 13, the tag 1315 “debriefing session” of the message 1311 is acquired. In this example, only one tag is to be acquired. However, when there is a plurality of message IDs, all corresponding tags are extracted. All extracted tags corresponding to messages are transmitted to the request processing unit 562.

In step S807, the request processing unit 562 adds all the tags acquired in step S806 to a tag list to be transmitted to the image processing apparatus 101.

Step S808 is a loop end, and the request processing unit 562 refers to the next owned file in the user owned file list corresponding to the user A to return the process to step S802.

In step S809, the request processing unit 562 requests the service communication unit 561 to transmit the tag list of similar image files created in steps S805 to S808 to the image processing apparatus 101. The service communication unit 561 transmits the tag list to the service communication unit 511 of the image processing apparatus 101, thus ending the processes of steps S614 to S617. In the example of FIG. 13, a tag to be transmitted is the tag 1315 “debriefing session”.

Referring back to the sequence chart of FIG. 6, in step S618, the service communication unit 511 of the image processing apparatus 101 acquires the tag list of similar image files to the image file A, and transmits that list to the request processing unit 512.

In step S619, the request processing unit 512 renders the message registration window 1101 shown in FIG. 11 on the operation unit 219. In this case, all the tags acquired in step S618 are transmitted to the UI control unit 514, and are reflected as recommend tag buttons 1104 on the message registration window 1101.

In step S620, the user A inputs a tag name to be attached to a message and message contents on the message registration window 1101 displayed on the operation unit 219, and presses the message registration button 1109. In this sequence, assume that the user A presses the recommend tag button 1104, and the input tag name is “debriefing session”.

In step S621, the request processing unit 512 of the applet application 510 transmits the input tag name and message contents to the service communication unit 511. The service communication unit 511 requests the microblog cooperative service server 141 to register a message in the microblog service server 131.

In step S622, the service communication unit 561 of the microblog cooperative service server 141 transmits the tag name and message contents received from the image processing apparatus 101 to the request processing unit 562. The request processing unit 562 requests the data management unit 565 to acquire the image file A, and acquires the image file A. The request processing unit 562 requests the microblog communication unit 563 to register a message. The message contents in this case are those input by the user A in step S620, and the tag name to be registered is that (in this example, “debriefing session”) also input by the user. Also, an image file to be attached is the image file A. The microblog communication unit 563 communicates with the microblog service server 131 to request it to register the message.

In step S623, upon reception of the message registration request from the microblog cooperative service server 141, the service communication unit 521 of the microblog service server 131 requests the request processing unit 522 to register the message. The request processing unit 522 transmits the message contents to the message management unit 525 and requests that unit to register the message in the message DB 550. Then, the request processing unit 522 receives a message ID issued by the message DB 550. Next, the request processing unit 522 transmits the image file A and corresponding message ID to the repository management unit 524, and requests the repository management unit 524 to register the image file A in the repository DB 540. The request processing unit 522 also transmits the tag name and corresponding message ID to the tag management unit 523 and requests that unit to register the tag in the tag DB 530. The service communication unit 521 transmits the message registration result to the microblog communication unit 563 as a response.

In step S624, the microblog communication unit 563 transmits the message registration result received from the microblog service server 131 to the request processing unit 562. The request processing unit 562 transmits the message registration result to the service communication unit 561, and requests that unit to transmit the result to the image processing apparatus 101. The service communication unit 561 transmits the message registration result to the service communication unit 511 of the image processing apparatus 101 as a response.

In step S625, the service communication unit 511 of the image processing apparatus 101 transmits the received message registration result to the request processing unit 512. The request processing unit 512 analyzes this result. When the registration has succeeded, the request processing unit 512 renders the message registration completion window 1201 shown in FIG. 12 on the operation unit 219. On the other hand, when the registration has failed, the request processing unit 512 notifies the user A of a registration error, and requests the user to redo the operation.

As described above, by following the sequence shown in FIG. 6, the same tag as the tag 1315 can be registered in a message in the microblog service server 131.

[Processing Result]

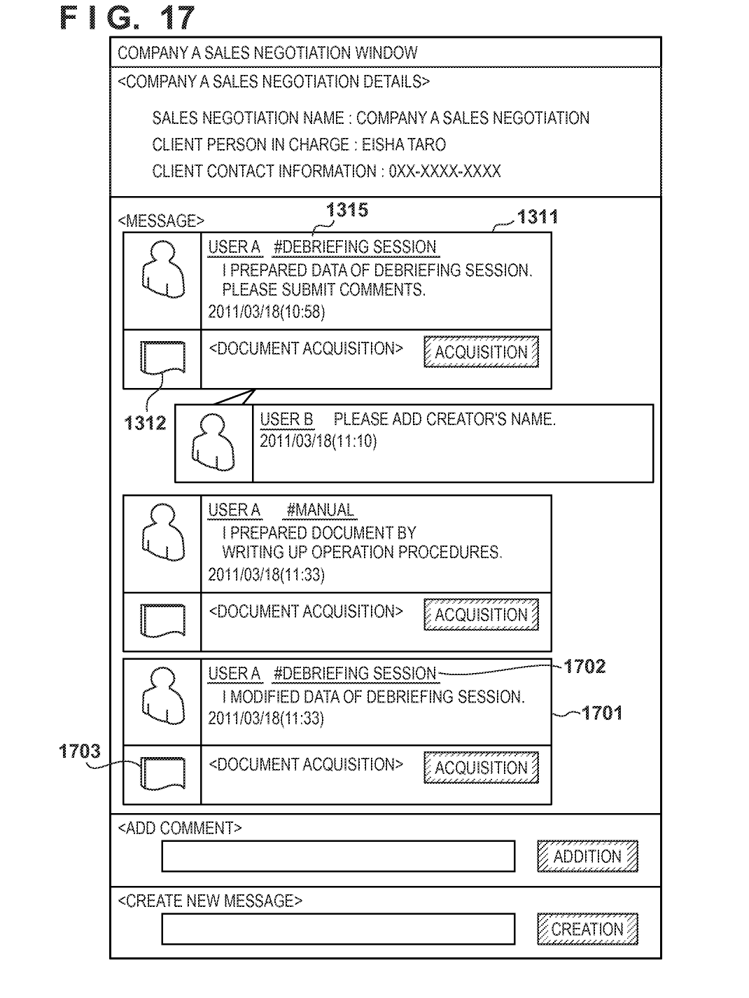

FIG. 17 shows a display example of a Web page displayed when the user accesses the microblog service server 131 from the Web browser that runs on the terminal 102. The state at this time is a state after the user A in FIG. 13 registers a message 1701 by attaching the image file shown in FIG. 15 by following the sequence shown in FIG. 6.

The message 1701 includes character string information “Data of the debriefing session is modified.” An image file 1703 obtained by user A modifying the image file 1312 is attached, and a tag 1702 (“debriefing session”) which is the same as the tag 1315 in the message 1311 is registered.

As can be seen from the above description, the same tag as the tag 1315 of the message 1311 appended with the similar image file 1312 is registered, and the new message 1701 can be registered by following the sequence shown in FIG. 6. The user can easily confirm the messages 1311 and 1701 in association with each other on the timeline with reference to the tag 1702. Thus, a modification process of the image file registered in the message of the microblog function can be easily confirmed on the microblog.

### Second Embodiment

As the second embodiment, a mode for registering a new tag even in a message appended with a similar image file will be provided.

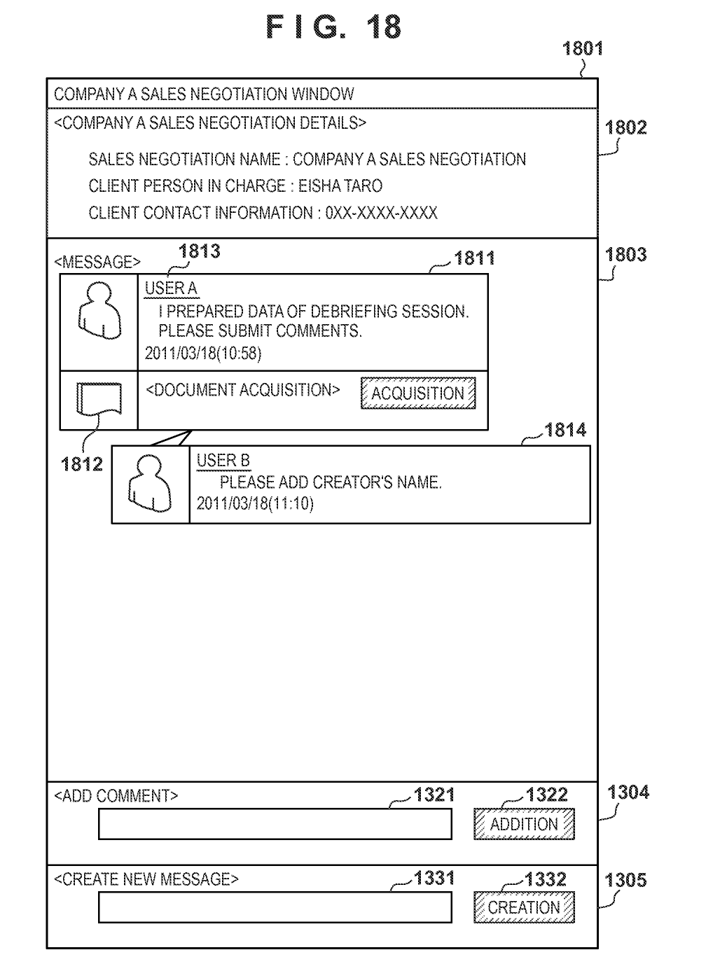

The first embodiment has provided the mode in which upon registration of a message by attaching an image file, a tag of a message attached with a similar image file is referred to, and the same tag is registered in the message. However, it is possible that no tag is registered in a message attached with a similar image, as shown in FIG. 18. According to the second embodiment, even when no tag is registered in a message attached with a similar image, as shown in FIG. 18, that message can be associated with a new message and tag to be registered.

[User Interface]

FIG. 18 is a view for explaining a microblog function provided by a microblog service server 131 to which the present invention is applicable. FIG. 18 shows a display example of a Web page displayed when the user accesses from a Web browser that runs on a terminal 102 to the microblog service server 131. Assume that the microblog service server 131 manages messages and comments for sales negotiation information which is currently in progress for the purpose of sharing information for a specific sales negotiation.

A company A sales negotiation window 1801 displays information related to a sales negotiation with company A. A sales negotiation detail area 1802 displays a sales negotiation name, client person in charge, client contact information, and the like as information related to the sales negotiation.

A message display area 1803 displays timelines including messages and comments for the messages. The message display area 1803 displays a state in which a user A registers a message 1811 “I prepared data of the debriefing session. Please input comments.” and an image file 1812. A comment 1814 is that for the message 1811. The message display area 1803 displays a state in which a user B replies to the message 1811 with the comment 1816 “Please add creator's name.”.

The items described so far are the same as the corresponding items shown in FIG. 13. Unlike in FIG. 13, no tag is registered in the message 1811. For this reason, in the sequence chart in FIG. 6, even when an image file of a new message to be registered is a similar image of the image file 1812, a recommend tag cannot be presented to the user A, and the new message cannot be associated with the message 1811.

[Processing Sequence]

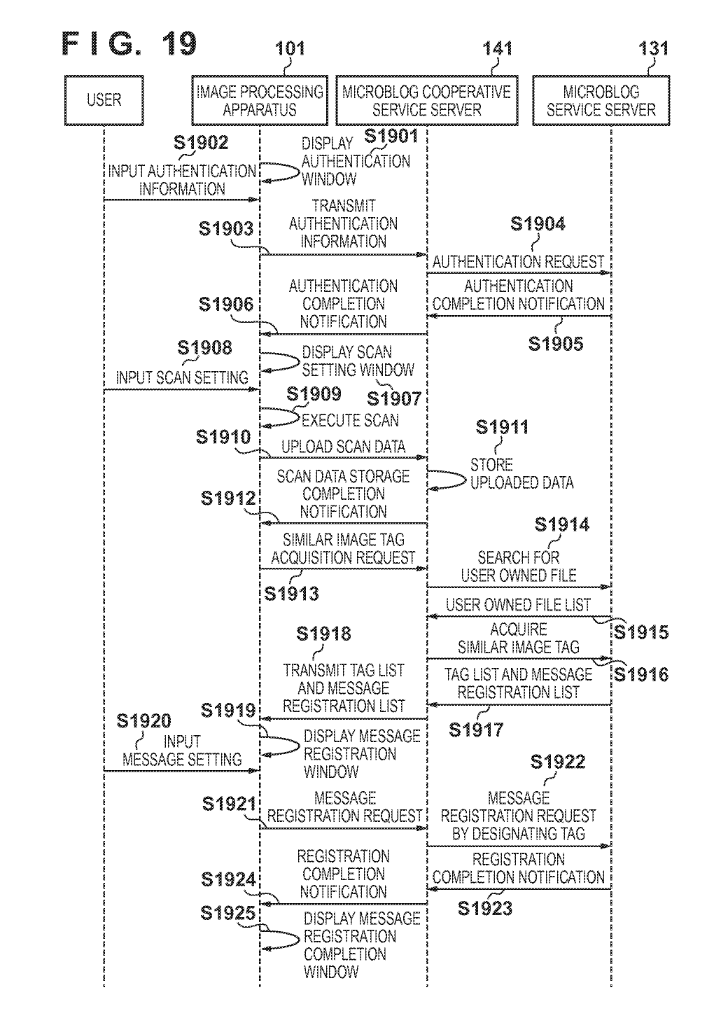

FIG. 19 is a sequence chart for explaining operations required to execute a series of processes of the user of an image processing apparatus 101, the image processing apparatus 101, a microblog cooperative service server 141, and the microblog service server 131 according to the second embodiment of the present invention. Note that the user of the image processing apparatus 101 is the user A in FIG. 18 for the sake of simplicity, and will be described as the user A hereinafter.

Steps S1901 to S1915 are the same operations as those in steps S601 to S615 in FIG. 6, and a description thereof will not be repeated.

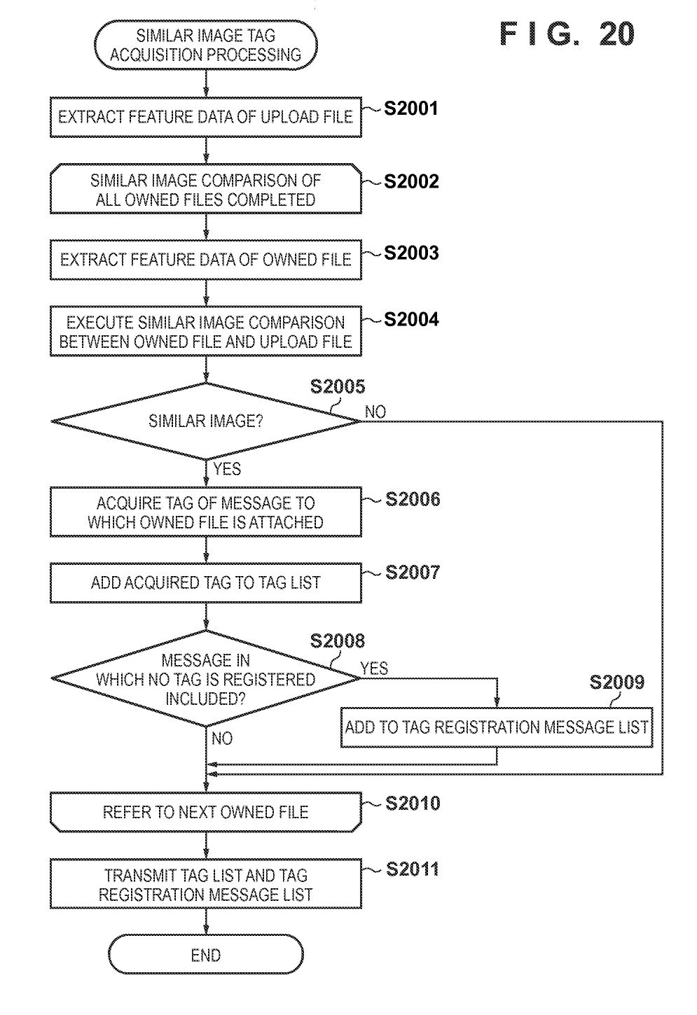

In steps S1916 and S1917, tag list acquisition processing is executed. This processing will be described in detail below with reference to FIG. 20.

(Similar Image Comparison Processing and Tag List Acquisition Processing)

FIG. 20 is a flowchart for explaining the operation of similar image comparison processing and tag list acquisition processing by the microblog cooperative service server 141 according to the second embodiment of the present invention. This processing sequence is implemented when a CPU of the microblog cooperative service server 141 reads out a program stored in an HDD or the like as a storage unit onto a RAM, and executes the readout program.

Steps S2001 to S2007 are the same operations as those in steps S801 to S807 in FIG. 8, and a description thereof will not be repeated.

A request processing unit 562 judges in step S2008 whether or not messages attached with similar image files include that in which no tag is registered. In this case, if a message in which no tag is registered is not included (NO in step S2008), the process advances to step S2010, and a process of step S2009 is skipped. If a message in which no tag is registered is included (YES in step S2008), the process advances to step S2009. In the example of FIG. 18, since no tag is registered in the message 1811 in which the image file 1812 as a similar image file of an image file A is registered, the process of step S2009 is executed.

In step S2009, the request processing unit 562 adds a message ID of the message in which no tag is registered to a tag registration message list. In the example of FIG. 18, the message ID of the message 1811 is added. Note that the tag registration message list is a list used to indicate a message in which no tag is registered, and is held in a storage unit such as an HDD. Also, the tag registration message list may be initialized together with a tag list when this processing sequence is started.

Since step S2010 is the same as step S808 in FIG. 8, a description thereof will not be repeated.

In step S2011, the request processing unit 562 requests a service communication unit 561 to transmit the tag list of similar image files and the tag registration message list created in steps S2005 to S2010 to the image processing apparatus 101. The service communication unit 561 transmits the tag list and tag registration message list to a service communication unit 511 of the image processing apparatus 101. In this way, the processes of steps S1916 and S1917 are complete. In the example of FIG. 18, no tag is transmitted, but the tag registration message list to be transmitted includes the message ID indicating the message 1811.

Referring back to the sequence chart of FIG. 19, in step S1918, the service communication unit 511 of the image processing apparatus 101 acquires the tag list of similar image files of the image file A and the tag registration message list, and transmits these list to a request processing unit 512.

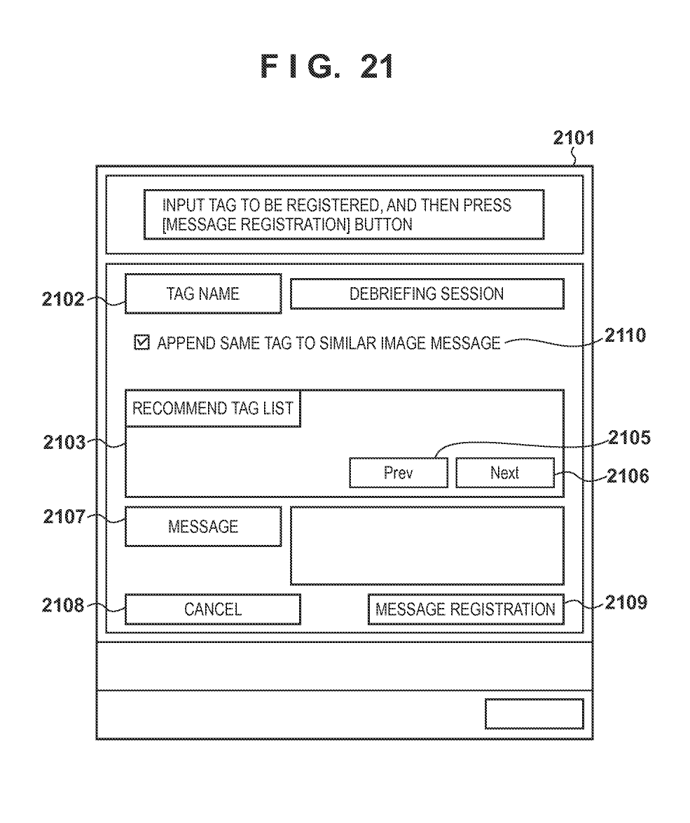

In step S1919, the request processing unit 512 renders a message registration window 2101 shown in FIG. 21 on an operation unit 219. In this case, all tags acquired in step S1918 are transmitted to a UI control unit 514, and are reflected as recommend tag buttons. Furthermore, when the tag registration message list acquired in step S1918 includes a message ID, a check box 2110 is displayed.

The check box 2110 shown in FIG. 21 is used to prompt the user to register a tag name input in a tag name input field 2102 also to a message in which a similar image file is registered.

In step S1920, the user A inputs a tag name to be attached to a message and message contents on the message registration window 2101 displayed on the operation unit 219, and presses a message registration button 2109. In this sequence, assume that the user A presses the message registration button 2109 after he or she inputs “debriefing session” in the tag name input field 2102, and checks the check box 2110.

In step S1921, a request processing unit 512 of an applet application 510 transmits the tag name and message contents input by the user to the service communication unit 511. Also, when the check box 2110 is checked, the request processing unit 512 also transmits the tag registration message list to a service communication unit 511. The service communication unit 511 requests the microblog cooperative service server 141 to register a message in the microblog service server 131.

In step S1922, the service communication unit 561 of the microblog cooperative service server 141 transmits the tag name and message contents received from the image processing apparatus 101 to the request processing unit 562. When the tag registration message list is received, the service communication unit 561 also transmits that list to the request processing unit 562. The request processing unit 562 requests a data management unit 565 to acquire the image file A, and acquires the image file A.

The request processing unit 562 requests a microblog communication unit 563 to register a message. Message contents in this case correspond to character string information input by the user in step S1920, and a tag name to be registered is that also input by the user. An image file to be attached is the image file A. Furthermore, upon reception of an addition request of a comment to a message, the request processing unit 562 requests the microblog communication unit 563 to add a comment to that message. Comment contents in this case correspond to the tag name input by the user. The microblog communication unit 563 communicates with the microblog service server 131 to request it to register a message and to add a comment.

In step S1923, upon reception of the message registration request and comment addition request from the microblog cooperative service server 141, a service communication unit 521 of the microblog service server 131 requests a request processing unit 522 to execute this processing. The request processing unit 522 transmits the message contents to a message management unit 525 to request that unit to register the message in a message DB 550. Then, the request processing unit 522 receives a message ID issued by the message DB 550.

Next, the request processing unit 522 transmits the image file A and corresponding message ID to a repository management unit 524, and requests that unit to register the image file A in a repository DB 540. The request processing unit 522 similarly transmits the tag name and corresponding message ID to a tag management unit 523, and requests that unit to register the tag name in a tag DB 530. Furthermore, upon reception of the comment addition request, the request processing unit 522 transmits a comment to be added and corresponding message ID to a message management unit 525, and requests that unit to add the comment in a message DB 550. Moreover, the request processing unit 522 transmits the tag name and corresponding message ID to the tag management unit 523, and requests that unit to register the tag name in the tag DB 530. The service communication unit 521 transmits a message registration result to the microblog communication unit 563 of the microblog cooperative service server 141 as a response.

Since steps S1924 and S1925 are the same as steps S624 and S625, a description thereof will not be repeated. As described above, by following the sequence shown in FIG. 19, a message is registered by registering a tag, and the same tag can be associated with the message 1811 at the same time.

[Processing Result]

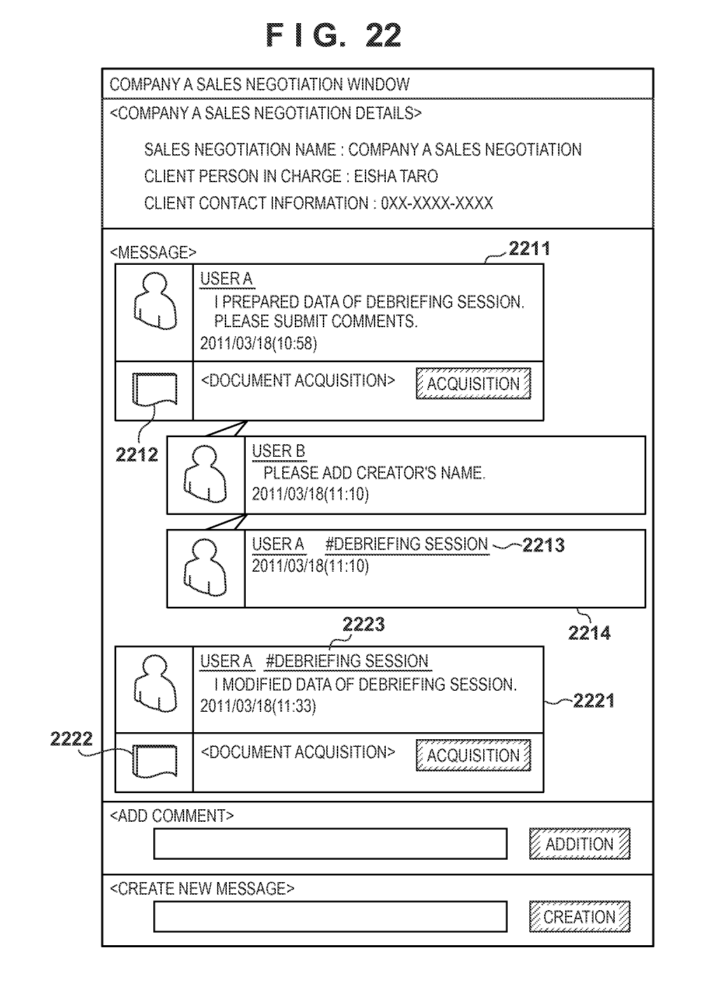

FIG. 22 shows a display example of a Web page displayed when the user accesses the microblog service server 131 from the Web browser that runs on the terminal 102. The state at this time is a state after the user A in FIG. 18 follows the sequence shown in FIG. 19.

A message 2221 includes character string information “Data of the debriefing session is modified.” An image file 2222 obtained by user A modifying an image file 2212 is attached, and the tag name input to the tag name input field 2102 is registered as a tag 2223.

A comment 2214 is added by following the sequence of FIG. 19, and describes the same tag name as the tag 2223, thus registering a tag 2213 in the message 2211. Registration of a comment by appending a tag implements a second registration unit. As described above, even when no tag is registered in a message attached with a similar image, that message can be associated with a new message and tag to be registered. As a result, the user can easily confirm a modification process of an image file registered in a message of the microblog function on the microblog.

### Third Embodiment

As the third embodiment, a mode for executing tag registration in the first embodiment as comment addition will be provided.

The first embodiment has provided the mode for registering a tag as a message upon registering the message while attaching an image file. However, depending on the specification of the microblog function a tag cannot often be registered simultaneously with message registration. The third embodiment provides the mode that allows tag registration even when a tag cannot be registered at the time of message registration.

[Processing Sequence]

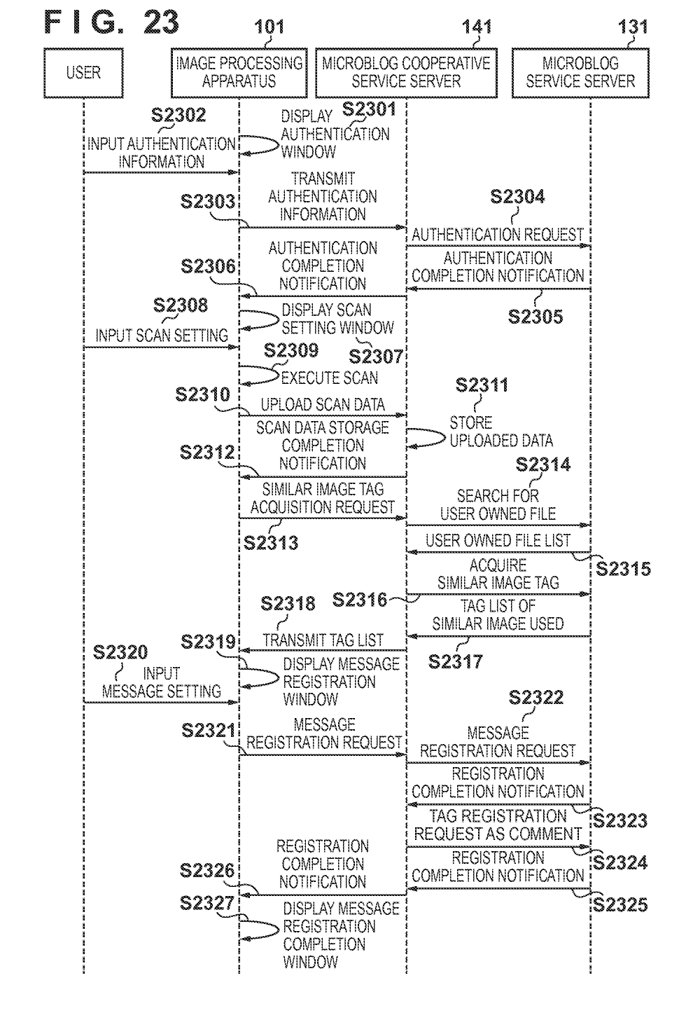

FIG. 23 is a sequence chart for explaining operations required to execute a series of processes of the user of an image processing apparatus 101, the image processing apparatus 101, a microblog cooperative service server 141, and a microblog service server 131 according to the third embodiment of the present invention. Note that the user of the image processing apparatus 101 is the user A in FIG. 13 for the sake of simplicity, and will be described as the user A hereinafter.

Steps S2301 to S2321 are the same operations as those in steps S601 to S621 in FIG. 6, and a description thereof will not be repeated.

In step S2322, a service communication unit 561 of the microblog cooperative service server 141 transmits a tag name and message contents received from the image processing apparatus 101 to a request processing unit 562. The request processing unit 562 requests a data management unit 565 to acquire an image file A, and acquires the image file A. The request processing unit 562 requests a microblog communication unit 563 to register a message. In this case, message contents are empty, and an image file to be attached is the image file A. The microblog communication unit 563 communicates with the microblog service server 131 to register a message.

In step S2323, upon reception of the message registration request from the microblog cooperative service server 141, a service communication unit 521 of the microblog service server 131 requests a request processing unit 522 to register a message. Then, the request processing unit 522 transmits the message contents to a message management unit 525 and requests that unit to register the message in a message DB 550. Also, the request processing unit 522 receives an issued message ID. Next, the request processing unit 522 transmits the image file A and corresponding message ID to a repository management unit 524, and requests that unit to register the image file A in a repository DB 540. The service communication unit 521 transmits a message registration result to the microblog communication unit 563 of the microblog cooperative service server 141 as a response to the message registration request.

In step S2324, the microblog communication unit 563 of the microblog cooperative service server 141 transmits the message registration result received from the microblog service server 131 to the request processing unit 562. When the message registration result indicates a success, the request processing unit 562 requests the microblog communication unit 563 to add a comment and to register a tag in the message registered in step S2322. In this case, comment contents are the contents of the message input by the user A in step S2320, and a tag name to be registered is similarly that input by the user A. The microblog communication unit 563 communicates with the microblog service server 131 to add a comment and to register a tag.

In step S2325, upon reception of the comment addition request from the microblog cooperative service server 141, the service communication unit 521 of the microblog service server 131 requests the request processing unit 522 to add a comment and to register a tag. The request processing unit 522 transmits the comment to be added to the message corresponding to the message ID to the message management unit 525. Next, the request processing unit 522 transmits the tag name and corresponding message ID to a tag management unit 523, and requests that unit to register the tag in a tag DB 530. After that, the service communication unit 521 transmits a comment addition result to the request processing unit 562 of the microblog cooperative service server 141.

Steps S2326 and S2327 are the same as steps S624 and S625, and a description thereof will not be repeated. As described above, by following the sequence of FIG. 23, even when a tag cannot be registered at the time of message registration depending on the specification or the like of the microblog function, the same effect as in the first embodiment can be obtained by designating a tag at the time of comment addition.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-188924, filed Aug. 29, 2012, which is hereby incorporated by reference herein in its entirety.

What is claimed is:

1. An information processing apparatus, which communicates with a server which manages character string information, a data file associated with the character string information, and character string information added in association with the character string information, said apparatus comprising:
a receiving unit configured to receive character string information and a data file to be associated with the character string information from a user;
an extraction unit configured to extract a data file similar to the data file received by said receiving unit and character string information associated with the similar data file by searching information managed by the server;
an acquisition unit configured to acquire tag information appended to the character string information extracted by said extraction unit; and
a registration unit configured to append the tag information acquired by said acquisition unit to the character string information received by said receiving unit, and to register the character string information appended with the tag information and the data file received by said receiving unit in the server in association with each other.

2. The apparatus according to claim 1, further comprising a second registration unit configured to append tag information to character string information to be added in association with character string information and to register the character string information in the server,
wherein when tag information is not appended to the character string information extracted by said extraction unit,
said registration unit appends new tag information to the character string information received by said receiving unit, and registers the character string information appended with the new tag information and the data file received by said receiving unit in the server in association with each other, and
said second registration unit appends the new tag information to character string information to be added in association with the character string information extracted by said extraction unit, and registers the character string information in the server.

3. The apparatus according to claim 1, wherein said extraction unit searches information managed by the user using information of the user whose data file is received by said receiving unit.

4. The apparatus according to claim 1, further comprising a unit configured to present tag information acquired by said acquisition unit to the user, and to prompt the user to select tag information to be appended to character string information by said registration unit.

5. An information processing apparatus connected to a server which manages character string information and character string information added in association with the character string information, said apparatus comprising:
a registration unit configured to append, when tag information is not appended to character string information managed by the server, new tag information to the character string information added in association with the character string information, and to register the character string information in the server.

6. The apparatus according to claim 2, further comprising a unit configured to receive the new tag information from the user.

7. A system including a server and an information processing apparatus,
wherein said server comprises:
a management unit configured to manage character string information, a data file associated with the character string information, and character string information added in association with the character string information; and
a display unit configured to provide a window used to display information managed by said management unit based on association of the information, and
said information processing apparatus comprises:
a receiving unit configured to receive character string information and a data file to be associated with the character string information from a user;
an extraction unit configured to extract a data file similar to the data file received by said receiving unit and character string information associated with the similar data file by searching information managed by said server;
an acquisition unit configured to acquire tag information appended to the character string information extracted by said extraction unit; and
a registration unit configured to append the tag information acquired by said acquisition unit to the character string information received by said receiving unit, and to register the character string information appended with the tag information and the data file received by said receiving unit in said server in association with each other.

8. The system according to claim 7, wherein said display unit displays the tag information as a link to a window used to display a search result of information managed by said server using the tag information.

9. The system according to claim 7, wherein said server provides said management unit and said display unit by a microblog function.

10. A control method of information processing apparatus, which communicates with a server which manages character string information, a data file associated with the character string information, and character string information added in association with the character string information, the method comprising:
a receiving step of receiving character string information and a data file to be associated with the character string information from a user;
an extraction step of extracting a data file similar to the data file received in the receiving step and character string information associated with the similar data file by searching information managed by the server;
an acquisition step of acquiring tag information appended to the character string information extracted in the extraction step; and
a registration step of appending the tag information acquired in the acquisition step to the character string information received in the receiving step, and registering the character string information appended with the tag information and the data file received in the receiving step in the server in association with each other.

11. A control method of an information processing apparatus connected to a server which manages character string information and character string information added in association with the character string information, the method comprising:
a registration step of appending, when tag information is not appended to character string information managed by the server, new tag information to the character string information added in association with the character string information, and registering the character string information in the server.

12. A non-transitory computer-readable medium storing a program for controlling a computer, which communicates with a server which manages character string information, a data file associated with the character string information, and character string information added in association with the character string information, to function as:
a receiving unit configured to receive character string information and a data file to be associated with the character string information from a user;
an extraction unit configured to extract a data file similar to the data file received by said receiving unit and character string information associated with the similar data file by searching information managed by the server;
an acquisition unit configured to acquire tag information appended to the character string information extracted by said extraction unit; and
a registration unit configured to append the tag information acquired by said acquisition unit to the character string information received by said receiving unit, and to register the character string information appended with the tag information and the data file received by said receiving unit in the server in association with each other.

13. A non-transitory computer-readable medium storing a program for controlling a computer, which communicates with a server which manages character string information and character string information added in association with the character string information, to function as:
a registration unit configured to append, when tag information is not appended to character string information managed by the server, new tag information to the character string information added in association with the character string information, and to register the character string information in the server.
